(19) United States
(12) Patent Application Publication
(10) Pub. No.: US 2026/0346582 A1
(43) Pub. Date: Nov. 5, 2026

(54) STRENGTH-ENHANCED ENGINEERED STRUCTURAL MATERIALS, AND METHODS FOR FABRICATION AND USE THEREOF

(71) Applicants: UNIVERSITY OF MARYLAND, COLLEGE PARK, College Park, MD (US); INVENTWOOD INC., Frederick, MD (US)

(72) Inventors: Liangbing HU, Woodbridge, CT (US); Yu LIU, Berwyn Heights, MD (US); Jiaqi DAI, Washington, DC (US); Allan BRADSHAW, Lake Tapps, WA (US)

(21) Appl. No.: 19/105,117

(22) PCT Filed: Aug. 22, 2023
(86) PCT No.: PCT/US2023/030783

§ 371 Date: Feb. 20, 2025

Related U.S. Application Data
(60) Provisional application No. 63/399,795, filed on Aug. 22, 2022.

(51) Int. Cl. B32B 23/04; B32B 21/04; B32B 21/13; B32B 37/12

(52) U.S. Cl. CPC B32B 23/044; B32B 21/042; B32B 21/13; B32B 37/12; B32B 2250/44; B32B 2317/16

(57) ABSTRACT

An engineered structure can comprise a first laminate having a plurality of constituent plant material layers. The plurality of constituent plant material layers can comprise one or more first layers and one or more second layers. Each plant material layer can be adhered to an adjacent plant material layer via glue. Each first layer can be a densified plant material layer having a density greater than or equal to 1.15 g/cm³ and a first mechanical strength. Each second layer can be a plant material layer having a density less than 1.15 g/cm³ and a second mechanical strength less than the first mechanical strength. For example, the plant material of each layer may be wood or bamboo.

### CROSS-REFERENCE TO RELATED APPLICATIONS

The present application claims the benefit of U.S. Provisional Application No. 63/399,795, filed Aug. 22, 2022, entitled “Strength-Enhanced Engineered Structural Materials, and Methods for Fabrication and Use Thereof,” which is hereby incorporated by reference herein in its entirety.

### STATEMENT REGARDING FEDERALLY SPONSORED RESEARCH

This invention was made with Government support under DEAR0001025 awarded by the Department of Energy, Advanced Research Projects Agency-Energy (DOE ARPA-E). The Government has certain rights in this invention.

### FIELD

The present disclosure relates generally to engineered structural materials, and more particularly, to strength-enhanced structures employing plant materials (e.g., wood, bamboo, etc.), such as, but not limited to, cross-laminated timber (CLT), glued laminated timber (glulam), laminated veneer lumber (LVL), oriented strand board (OSB), and/or oriented structural straw board (OSSB).

### BACKGROUND

Engineered wood is attractive for replacing CO₂ intensive construction materials (e.g., concrete, steel, ceramics, etc.) with the aim of achieving carbon negative buildings. However, the performance of engineered wood (e.g., the stiffness) must be further improved to expand its use. Cross-laminated timber (CLT) is the newest engineered wood product (commonly referred to as mass timber), which can replace concrete in buildings at a fraction of the weight and carbon footprint. While CLTs typically have sufficient strength, they lack the stiffness to match the span of reinforced concrete slabs, thereby requiring thicker flooring systems and more closely spaced columns as compared to their concrete counterparts, which in turn increases construction costs.

Embodiments of the disclosed subject matter may address one or more of the above-noted problems and disadvantages, among other things.

### SUMMARY

Embodiments of the disclosed subject matter system provide engineered structural materials with enhanced mechanical strength. In some embodiments, the engineered structural material comprises multiple plant material layers (e.g., comprising one or more plant material pieces) glued, adhered, joined, or otherwise coupled together to form a laminate. At least one of the plant material layers within the laminate can be a densified plant material layer (e.g., comprising one or more densified plant material pieces), for example, compressed to collapse lumina of its native cellulose-based microstructure so as to have an increased density of at least 1.15 g/cm³. In some embodiments, the densified plant material layer can be formed from lignin-compromised material, for example, in situ lignin-modified plant material or partially delignified plant material. In some embodiments, the densified plant material layer can reinforce the overall structure, thereby allowing the other plant material layers to have a lower strength, allowing the laminate to be used in a more demanding application, and/or allowing the laminate to have a smaller cross-section.

In one or more embodiments, an engineered structure can comprise a first laminate. The first laminate can comprise a plurality of constituent plant material layers. The plurality of constituent plant material layers can comprise one or more first layers and one or more second layers. Each plant material layer can be adhered to an adjacent plant material layer via one or more respective glues. Each first plant material layer can be a densified plant material layer having a density greater than or equal to 1.15 g/cm³ and a mechanical strength greater than or equal to a first value. Each second plant material layer can be a plant material layer having a density less than 1.15 g/cm³ and a mechanical strength less than the first value.

In one or more embodiments, an engineered structural material can comprise one or more laminate structures. Each laminate structure can have a plurality of constituent plant material layers. Each plant material layer can be coupled to an adjacent plant material layer via one or more respective glues. At least one of the plurality of constituent plant material layers can be a densified plant material layer having a density greater than or equal to 1.15 g/cm³.

In one or more embodiments, a method can comprise providing one or more first layers. Each first layer can comprise a densified plant material having a density greater than or equal to 1.15 g/cm³ and a mechanical strength greater than or equal to a first value. The method can further comprise providing one or more second layers. Each second layer can comprise a plant material having a density less than 1.15 g/cm³ and a mechanical strength less than the first value. The method can also comprise coupling the one or more first layers to the one or more second layers via one or more respective glues so as to form a laminate.

Any of the various innovations of this disclosure can be used in combination or separately. This summary is provided to introduce a selection of concepts in a simplified form that are further described below in the detailed description. This summary is not intended to identify key features or essential features of the claimed subject matter, nor is it intended to be used to limit the scope of the claimed subject matter. The foregoing and other objects, features, and advantages of the disclosed technology will become more apparent from the following detailed description, which proceeds with reference to the accompanying figures.

### BRIEF DESCRIPTION OF THE DRAWINGS

Embodiments will hereinafter be described with reference to the accompanying drawings, which have not necessarily been drawn to scale. Where applicable, some elements may be simplified or otherwise not illustrated in order to assist in the illustration and description of underlying features. Throughout the figures, like reference numerals denote like elements.

FIGS. 1A-1G are simplified schematic diagrams of various strength-enhanced engineered structures formed from one or more plant materials, according to one or more embodiments of the disclosed subject matter.

FIGS. 2A-2B are partial isometric views of strength-enhanced cross-laminated timber (CLT) structures, according to one or more embodiments of the disclosed subject matter.

FIGS. 3A-3D are partial isometric views of various strength-enhanced glued laminated timber (glulam) structures, according to one or more embodiments of the disclosed subject matter.

FIGS. 4A-4D are partial isometric views of various strength-enhanced laminated veneer lumber (LVL) structures, according to one or more embodiments of the disclosed subject matter. FIGS. 5A-5E show various strength-enhanced I-joist structures, according to one or more embodiments of the disclosed subject matter.

FIG. 6 is a simplified process-flow diagram for fabricating a strength-enhanced engineered structure from one or more plant materials, according to one or more embodiments of the disclosed subject matter.

### DETAILED DESCRIPTION

### General Considerations

For purposes of this description, certain aspects, advantages, and novel features of the embodiments of this disclosure are described herein. The disclosed methods and systems should not be construed as being limiting in any way. Instead, the present disclosure is directed toward all novel and nonobvious features and aspects of the various disclosed embodiments, alone and in various combinations and sub-combinations with one another. The methods and systems are not limited to any specific aspect or feature or combination thereof, nor do the disclosed embodiments require that any one or more specific advantages be present, or problems be solved. The technologies from any embodiment or example can be combined with the technologies described in any one or more of the other embodiments or examples. In view of the many possible embodiments to which the principles of the disclosed technology may be applied, it should be recognized that the illustrated embodiments are exemplary only and should not be taken as limiting the scope of the disclosed technology.

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed methods can be used in conjunction with other methods. Additionally, the description sometimes uses terms like “provide” or “achieve” to describe the disclosed methods. These terms are high-level abstractions of the actual operations that are performed. The actual operations that correspond to these terms may vary depending on the particular implementation and are readily discernible by one skilled in the art.

The disclosure of numerical ranges should be understood as referring to each discrete point within the range, inclusive of endpoints, unless otherwise noted. Unless otherwise indicated, all numbers expressing quantities of components, molecular weights, percentages, temperatures, times, and so forth, as used in the specification or claims are to be understood as being modified by the term “about.” Accordingly, unless otherwise implicitly or explicitly indicated, or unless the context is properly understood by a person skilled in the art to have a more definitive construction, the numerical parameters set forth are approximations that may depend on the desired properties sought and/or limits of detection under standard test conditions/methods, as known to those skilled in the art. When directly and explicitly distinguishing embodiments from discussed prior art, the embodiment numbers are not approximates unless the word “about,” “substantially,” or “approximately” is recited. Whenever “substantially,” “approximately,” “about,” or similar language is explicitly used in combination with a specific value, variations up to and including 10% of that value are intended, unless explicitly stated otherwise.

Directions and other relative references may be used to facilitate discussion of the drawings and principles herein but are not intended to be limiting. For example, certain terms may be used such as “inner,” “outer,” “upper,” “lower,” “top,” “bottom,” “interior,” “exterior,” “left,” right,” “front,” “back,” “rear,” and the like. Such terms are used, where applicable, to provide some clarity of description when dealing with relative relationships, particularly with respect to the illustrated embodiments. Such terms are not, however, intended to imply absolute relationships, positions, and/or orientations. For example, with respect to an object, an “upper” part can become a “lower” part simply by turning the object over. Nevertheless, it is still the same part, and the object remains the same.

As used herein, “comprising” means “including,” and the singular forms “a” or “an” or “the” include plural references unless the context clearly dictates otherwise. The term “or” refers to a single element of stated alternative elements or a combination of two or more elements unless the context clearly indicates otherwise.

Although there are alternatives for various components, parameters, operating conditions, etc. set forth herein, that does not mean that those alternatives are necessarily equivalent and/or perform equally well. Nor does it mean that the alternatives are listed in a preferred order, unless stated otherwise. Unless stated otherwise, any of the groups defined below can be substituted or unsubstituted.

Unless explained otherwise, all technical and scientific terms used herein have the same meaning as commonly understood to one skilled in the art to which this disclosure belongs. Although methods and materials similar or equivalent to those described herein can be used in the practice or testing of the present disclosure, suitable methods and materials are described below. The materials, methods, and examples are illustrative only and not intended to be limiting. Features of the presently disclosed subject matter will be apparent from the following detailed description and the appended claims.

### Overview of Terms

The following are provided to facilitate the description of various aspects of the disclosed subject matter and to guide those skilled in the art in the practice of the disclosed subject matter.

Plant Material: A portion (e.g., a cut piece or portion, via mechanical means or otherwise) of any photosynthetic eukaryote of the kingdom Plantae in its native state as grown. In some embodiments, the plant material comprises wood (e.g., hardwood or softwood), bamboo (e.g., any of Bambusoideae, such as but not limited to Moso, Phyllostachys vivax, Phyllostachys viridis, Phyllostachys bambusoides, and Phyllostachys nigra), reed (e.g., any of common reed (Phragmites australis), giant reed (Arundo donax), Burma reed (Neyraudia reynaudiana), reed canary-grass (Phalaris arundinacea), reed sweet-grass (Glyceria maxima), small-reed (Calamagrostis species), paper reed (Cyperus papyrus), bur-reed (Sparganium species), reed-mace (Typha species), cape thatching reed (Elegia tectorum), and thatching reed (Thamnochortus insignis)), or grass (e.g., a species selected from the Poales order or the Poaceae family). For example, the natural wood can be any type of hardwood (e.g., having a native lignin content in a range of 18-25 wt %) or softwood (e.g., having a native lignin content in a range of 25-35 wt %), such as, but not limited to, basswood, oak, poplar, ash, alder, aspen, balsa wood, beech, birch, cherry, butternut, chestnut, cocobolo, elm, hickory, maple, oak, padauk, plum, walnut, willow, yellow poplar, bald cypress, cedar, cypress, douglas fir, fir, hemlock, larch, pine, redwood, spruce, tamarack, juniper, and yew. Alternatively, in some embodiments, the plant material can be any type of fibrous plant composed of lignin, hemicellulose, and cellulose. For example, the plant material can be bagasse (e.g., formed from processed remains of sugarcane or sorghum stalks) or straw (e.g., formed from processed remains of cereal plants, such as rice, wheat, millet, or maize).

Engineered Structure or Engineered Structural Material: A structure formed from a plurality of pieces or layers of natural or modified plant materials coupled together using glue or other adhesive to form a structure with improved strength and/or durability. Examples of such structures/materials include, but are not limited to, cross-laminated timber (CLT), glued laminated timber (glulam), laminated veneer lumber (LVL), oriented strand board (OSB), and/or oriented structural straw board (OSSB).

Lignin-compromised plant material: Plant material that has been modified by one or more chemical treatments to (a) in situ modify the native lignin therein, (b) partially remove the native lignin therein (i.e., partial delignification), or (c) fully remove the native lignin therein (i.e., full delignification). In some embodiments, the lignin-compromised plant material can substantially retain the native microstructure of the natural plant material formed by cellulose-based cell walls.

Partial Delignification: The removal of some (e.g., at least 1%) but not all (e.g., less than or equal 90%) of native lignin (e.g., on a weight percent basis) from the naturally-occurring plant material. In some embodiments, the partial delignification can be performed by subjecting the natural plant material to one or more chemical treatments. In some embodiments, the lignin content after partial delignification can be in a range of 0.9-23.8 wt % for hardwood or in a range of 1.25-33.25 wt % for softwood. Lignin content within the plant material before and after the partial delignification can be assessed using known techniques in the art, for example, Laboratory Analytical Procedure (LAP) TP-510-42618 for “Determination of Structural Carbohydrates and Lignin in Biomass,” Version 08-03-2012, published by National Renewable Energy Laboratory (NREL), and ASTM E1758-01(2020) for “Standard Test Method for Determination of Carbohydrates in Biomass by High Performance Liquid Chromatography,” published by ASTM International, both of which are incorporated herein by reference. In some embodiments, the partial delignification process can be, for example, as described in U.S. Publication No. 2020/0223091, published Jul. 16, 2020 and entitled “Strong and Tough Structural Wood Materials, and Methods for Fabricating and Use Thereof,” and U.S. Publication No. 2022/0412002, published Dec. 29, 2022 and entitled “Bamboo Structures, and Methods for Fabrication and Use Thereof,” which delignification and densification processes are incorporated herein by reference.

Full Delignification: The removal of substantially all (e.g., 90-100%) of native lignin from the naturally-occurring plant material. In some embodiments, the full delignification can be performed by subjecting the natural plant material to one or more chemical treatments. Lignin content within the plant material before and after the full delignification can be assessed using the same or similar techniques as those noted above for partial delignification. In some embodiments, the full delignification process can be, for example, as described in U.S. Publication No. 20200238565, published Jul. 30, 2020 and entitled “Delignified Wood Materials, and Methods for Fabricating and Use Thereof,” which delignification processes are incorporated herein by reference.

Lignin modification: In situ altering one or more properties of native lignin in the naturally-occurring plant material, without removing the altered lignin from the plant material. In some embodiments, the lignin content of the plant material prior to and after the in situ modification can be substantially the same, for example, such that the in situ modified plant material retains at least 95% (e.g., removing no more than 1%, or no more than 0.5%, of the native lignin content) of the native lignin content. In some embodiments, the plant material can be in situ modified (e.g., by chemical reaction with OH) to depolymerize lignin, with the depolymerized lignin being retained within the plant material microstructure. The lignin content within the plant material before and after lignin modification can be assessed using known techniques in the art, for example, Laboratory Analytical Procedure (LAP) TP-510-42618 for “Determination of Structural Carbohydrates and Lignin in Biomass,” Version 08-03-2012, published by National Renewable Energy Laboratory (NREL), ASTM E1758-01(2020) for “Standard Test Method for Determination of Carbohydrates in Biomass by High Performance Liquid Chromatography,” published by ASTM International, and/or Technical Association of Pulp and Paper Industry (TAPPI), Standard T 222-om-83, “Standard Test Method for Acid-Insoluble Lignin in Wood,” all of which are incorporated herein by reference. In some embodiments, the lignin modification process can be, for example, as described in International Publication No. WO 2023/028356, published Mar. 2, 2023, and entitled “Waste-free Processing for Lignin Modification of Fibrous Plant Materials, and Lignin-modified Fibrous Plant Materials,” which lignin modification processes are incorporated herein by reference.

Densified Plant Material or Densified Wood: A plant material (e.g., wood) that has been compressed to have a reduced thickness. In some embodiments, the thickness has been reduced by a factor of at least three. In some embodiments, the densified plant material (e.g., wood) can have a density greater than that of the native plant material, for example, at least 1.15 g/cm³, such as at least 1.2 g/cm³ or even at least 1.3 g/cm³ (e.g., 1.4-1.5 g/cm³). For example, the densified plant material can be formed as described in, but not limited to, U.S. Pat. No. 11,130,256, issued Sep. 28, 2021, entitled “Strong and Tough Structural Wood Materials, and Methods for Fabricating and Use Thereof,” and International Publication No. WO 2021/108576, published Jun. 3, 2021, entitled “Bamboo Structures, and Methods for Fabrication and Use Thereof,” each of which is incorporated herein by reference.

Non-densified Plant Material or Non-densified Wood: A plant material (e.g., wood) that substantially retains its native density. In some embodiments, the non-densified plant material (e.g., wood) can have a density of, for example, less than 1.15 g/cm³, such as less than or equal to 1.0 g/cm³ or even less than or equal to 0.9 g/cm³ (e.g., 0.1-0.9 g/cm³). In some embodiments, the lumina of the cellulose-based microstructure of the non-densified plant material can remain substantially open, at least prior to inclusion within the engineered structure.

Longitudinal growth direction: A direction along which a plant grows from its roots or from a trunk thereof, with cellulose fibers forming cell walls of the plant being generally aligned with the longitudinal growth direction. In some cases, the longitudinal growth direction may be generally vertical or correspond to a direction of its water transpiration stream. This is in contrast to the radial direction, which extends from a center portion of the plant outward and may be generally horizontal.

### Introduction

Disclosed herein are engineered structural materials formed from one or more plant materials. In some embodiments, the engineered structural materials can have enhanced mechanical strength, for example, as compared to existing engineered structural materials (e.g., formed with native or non-densified wood alone). As a result of the enhanced strength (e.g., stiffness, tensile strength, compressive strength, etc.), the engineered structural material can be made with a smaller cross-section (e.g., as compared to existing engineered structural materials) for a particular application (e.g., requiring a particular strength rating). Alternatively, in some embodiments, as a result of the enhanced strength, the engineered structural material with a same cross-section can be used in a more demanding application (e.g., as compared to existing engineered structural materials), for example, by spanning a longer distance. Alternatively or additionally, in some embodiments, the size and/or strength of the engineered structural material can be custom designed to a particular application by including an appropriate number and/or arrangement of densified plant material layers in the engineered structural material.

In some embodiments, the engineered structural materials comprises a laminate structure having a plurality of constituent plant material layers joined, adhered, or otherwise coupled to each other via a glue, with at least one of the layers being a densified plant material layer, for example, having a density of at least 1.15 g/cm³ (e.g., ≥1.2 g/cm³ or ≥1.3 g/cm³, for example, in a range of 1.4-1.5 g/cm³). In some embodiments, one, some, or all of other layers of the laminate structure can be non-densified plant material layers, for example, having a density less than 1.15 g/cm³ (e.g., ≤1.0 g/cm³ or ≤0.9 g/cm³, for example, in a range of 0.1-0.9 g/cm³). In some embodiments, the non-densified plant material layers can be formed of the native plant material (e.g., without compression). Alternatively or additionally, in some embodiments, one, some or all of the other layers of the laminate structure can be plant material layers that have been densified (e.g., prior to inclusion in the laminate or after inclusion in the laminate), but to a lesser degree than the densified plant material layers, for example, such that the densified density remains less than 1.15 g/cm³. In the following description, references to non-densified plant material layers are intended to include such lesser-densified plant material layers. In some embodiments, the densified plant material layers can have a mechanical strength greater than that of the other plant material layers (e.g. non-densified or lesser-densified). For example, each densified plant material layer can have a strength of at least 100 MPa (e.g., 100-600 MPa), while each non-densified plant material layer can have a strength less than 100 MPa (e.g., 15-65 MPa).

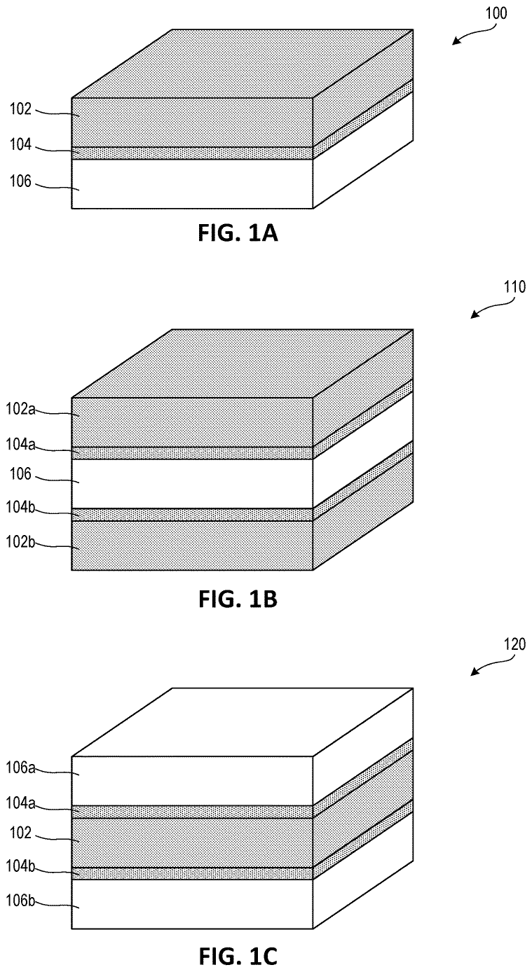

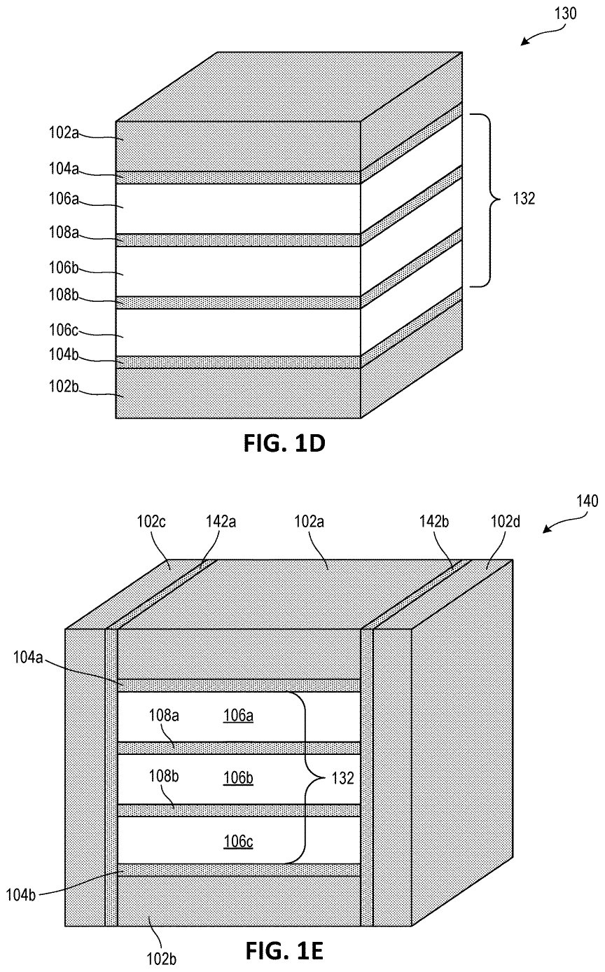

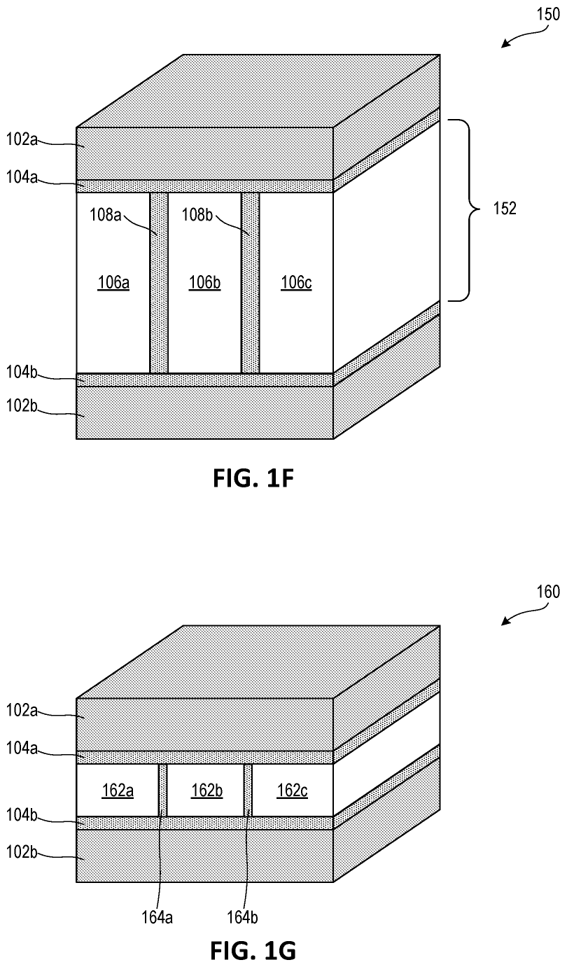

The laminate structure can have any number of plant material layers. For example, FIG. 1A illustrates a laminate structure 100 having a pair of plant material layers, in particular, a densified plant material layer 102 coupled to a non-densified plant material layer 106 via an intervening glue layer 104. For example, the glue layer 104 can comprise any type of adhesive, such as but not limited to epoxy, polyurethane adhesive, polyvinyl acetate-isocyanate adhesive, resorcinol formaldehyde resin adhesive, phenolic resin, and/or sodium carboxymethyl cellulose (CMC). Alternatively or additionally, in some embodiments, one, some, or all of the plant material layers constituting the laminate structure can be formed of multiple plant material pieces.

In some embodiments, at least one of the densified plant material layers can be disposed at a location within the laminate structure that would be subject to stresses that exceed a predetermined threshold and/or a maximum stress. In some embodiments, densified plant material layers can be used as outermost layers of the laminate structure in a cross-sectional view, for example, as shown in FIG. 1B. In the illustrated example of FIG. 1B, laminate structure 110 has three plant material layers-a pair of densified plant material layers 102a, 102b coupled to opposite sides of a centrally-disposed non-densified plant material layer 106 via respective intervening glue layers 104a, 104b. Alternatively or additionally, the densified plant material layer can be disposed at any location within the laminate structure. For example, as shown in FIG. 1C, densified plant material layers can be used as interior or central layers of the laminate structure in a cross-sectional view. In the illustrated example of FIG. 1C, laminate structure 120 has three plant material layers-a pair of non-densified plant material layers 106a, 106b coupled to a centrally-disposed densified plant material layer 102 via respective intervening glue layers 104a, 104b.

Although FIGS. 1A-1C illustrate a single densified plant material layer or a single non-densified plant material layer, embodiments of the disclosed subject matter are not limited thereto. Rather, in some embodiments, multiple densified plant material layers and multiple non-densified plant material layers can be provided together in a single laminate structure. For example, FIG. 1D illustrates a laminate structure 130 having more than three plant material layers. In the illustrated example, the laminate structure 130 has a stack 132 of three non-densified plant material layers 106a-106c coupled together via intervening glue layers 108a, 108b (which may be the same formulation or a different formulation than glue layers 104a, 104b). Other numbers of layers for stack 132 are also possible according to one or more contemplated embodiments, for example, 3, 5, or 7 layers for CLT structures, or 12-15 layers for LVL structures. Similar to the configuration of FIG. 1B, the laminate structure 130 has a pair of densified plant material layers 102a, 102b coupled to the centrally-disposed stack 132 via respective intervening glue layers 104a, 104b. In some embodiments, the stack 132 can be a conventional engineered structure (e.g., CLT, glulam, LVL, OSB, etc.), and the pair of densified plant material layers 102a, 102b can serve to enhance or reinforce the strength of the stack 132.

In the examples of FIGS. 1A-1D, lateral side surfaces of the non-densified plant material layers can be exposed. However, in some embodiments, densified plant material layers can also be provided over one, some, or all of these exposed surfaces, for example, to contain, bound, or otherwise enclose the non-densified plant material layers within a surrounding structure formed by the densified plant material layers. In some embodiments, the provision of densified plant material layers to enclose the non-densified plant material layers can form a post or beam that has improved aesthetics (e.g., more desirable appearance due to the densified layer as compared to the non-densified layers), improved durability (e.g., due to greater fire resistance and/or weatherability of the densified layer as compared to the non-densified layers), and/or installation flexibility (e.g., to provide enhanced strength regardless of orientation). For example, FIG. 1E illustrates a laminate structure 140 where the stack 132 of non-densified plant material layers 106a is capped on left and right sides thereof by densified plant material layers 102c, 102d and corresponding glue layers 142a, 142b, respectively (which may have a same or different formulation and/or thickness as glue layers 108a, 108b and/or glue layers 104a, 104b). In a manner similar to FIG. 1D, the top and bottom sides of the stack 132 of the laminate structure 140 are capped by densified plant material layers 102a, 102b, thereby enclosing the stack 132 within a circumferentially-surrounding wall formed by the densified plant material layers 102a-102d.

Although FIGS. 1D-1E illustrates non-densified plant material layers arranged in the stack along the thickness direction of the laminate structure, embodiments of the disclosed subject matter are not limited thereto. Rather, in some embodiments, the non-densified plant material layers can be stacked with respect to a width and/or length direction of the laminate structure. For example, FIG. 1F illustrates a laminate structure 150 having a lateral stack 152 of three non-densified plant material layers 106a-106c arranged along the width direction and coupled together via intervening layers 108a, 108b (which may the same or different formulation and/or thickness as glue layers 104a, 104b). As shown in FIG. 1F, a height of each non-densified plant material layer 106a-106c can be greater than a width thereof. In another example, FIG. 1G illustrates a laminate structure 160 having a lateral stack of three non-densified plant material layers 162a-162c arranged along the width direction and coupled together via intervening glue layers 164a, 164b (which may be the same or different formulation and/or thickness as glue layers 104a, 104b). As shown in FIG. 1G, a height of each non-densified plant material layer 162a-162c can be less than a width thereof. Other sizes and/or numbers of layers for the lateral stack are also possible according to one or more contemplated embodiments.

Similar to the configurations of FIGS. 1B and 1D, the laminate structures 150 and 160 have a pair of densified plant material layers 102a, 102b coupled to the centrally-disposed lateral stack via respective intervening glue layers 104a, 104b. In some embodiments, the lateral stack can be a conventional engineered structure (e.g., CLT, glulam, LVL, OSB, etc.), and the pair of densified plant material layers 102a, 102b can serve to enhance or reinforce the strength of the lateral stack.

Although FIGS. 1A-1G illustrate a laminate structure with at least one non-densified plant material layer, embodiments of the disclosed subject matter are not limited thereto. Rather, in some embodiments, each of the layers of the laminate structure can be a densified plant material layer (e.g., with each having a density greater than or equal to 1.15 g/cm³). In such embodiments, the separate densified plant material layers can be coupled to each other via intervening glue layers (e.g. similar to glue layer 104) or otherwise (e.g., without any glue and/or by relying on hydrogen bonding between facing surfaces of the densified plant material layers).

Although FIGS. 1A-1G illustrate one or two densified plant material layers, embodiments of the disclosed subject matter are not limited thereto. Rather, in some embodiments, more than two densified plant material layers can be included in the laminate structure. For example, in some embodiments, densified plant material layers can constitute 5-50% of the laminate structure (e.g., based on number of layers and/or by thickness and/or by weight), while the remaining 50-95% can constitute non-densified plant material layers. Alternatively, in some embodiments, the densified plant material layers can constitute a majority (e.g., >50%) of the laminate structure, with the remainder formed of non-densified plant material layers. Although FIGS. 1A-1G illustrate the densified plant material layers at specific locations (e.g., top, bottom, or middle) of the laminate structure, embodiments of the disclosed subject matter are not limited thereto. Rather, in some embodiments, the densified plant material layers can be at any location within the laminate structure, for example, replacing any of the non-densified wood layers illustrated in FIGS. 1A-1G.

Although FIGS. 1A-1G illustrate a single piece of plant material in each layer, embodiments of the disclosed subject matter are not limited thereto. Rather, in some embodiments, multiple plant material pieces can be coupled together (e.g., via mechanical joining techniques, such as finger joints, and/or adhesive) at adjacent edges to form a respective layer, for example, to extend a width and/or length of the layer. In some embodiments, the plant material for each layer of the laminate structure can be from the same plant, or at least the same species. Alternatively, in some embodiments, the plant material for at least one of the layers in the laminate structure can be from a different species than that of at least one other layer. Alternatively or additionally, in some embodiments, each of the densified plant material layers can be formed from a same species, and/or each of the non-densified plant material layers can be formed from a same species (which may be the same as or different from the densified plant material layers).

In some embodiments, the plant material layers can be arranged within the laminate structure such that their orientations (e.g., based on their respective longitudinal growth directions) are substantially aligned or parallel. Alternatively, in some embodiments, at least one of the plant material layers can be arranged within the laminate structure such that its orientation is substantially orthogonal to, or at least crossing, an orientation of at least another of the plant material layers. Alternatively or additionally, in some embodiments, each of the densified plant material layers can have substantially aligned orientations. Alternatively or additionally, each of the non-densified plant material layers can have orientations (which may be the same as or different from that of the densified plant material layers) that are substantially aligned, crossing, or substantially orthogonal. Alternatively or additionally, in some embodiments, one, some, or all of the plant material layers may have random orientations (e.g., without consideration of orientations of the other plant material layers).

Although the following sections primarily focus on engineered structural materials formed from wood, embodiments of the disclosed subject matter are not limited thereto. Rather, the teachings of the present disclosure can be readily extended to other plant materials (e.g., bamboo, straw, etc.).

### Examples of Engineered Wood Structures

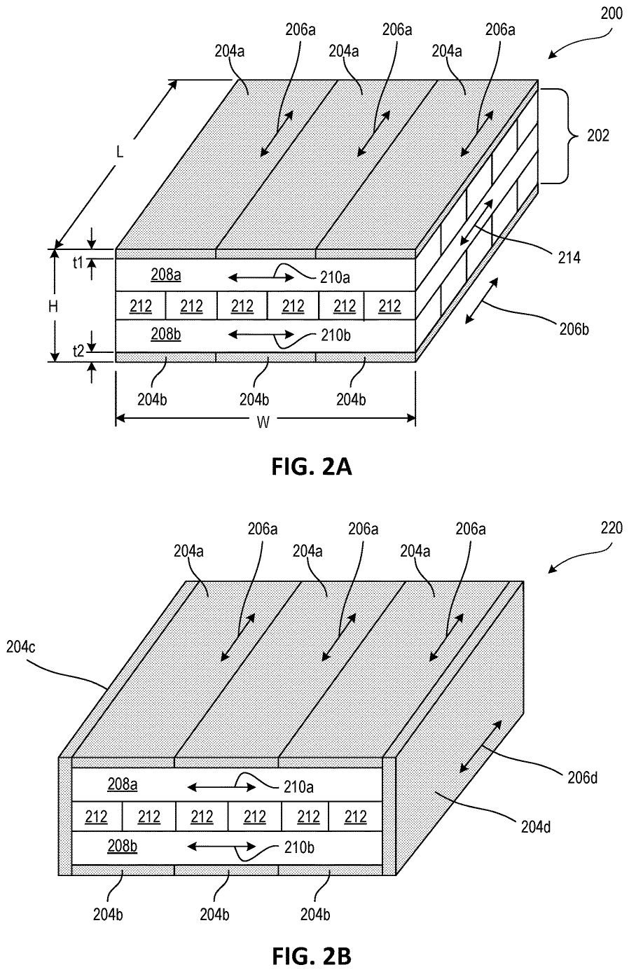

FIG. 2A illustrates a strength-enhanced cross-laminated timber (CLT) structure 200 having a laminate structure, with a stack 202 in between outer layers of densified wood panels 204a, 204b (e.g., having a thickness, t1 or t2, of 3/16-inch to ¼-inch (4.76 mm to 6.35 mm), such as ⅜-inch (9.35 mm)). In some embodiments, the stack 202 can be a conventional CLT structure, for example, having three layers (or five, or seven) of lumber boards. For example, in a cross-sectional plane perpendicular to the respective longitudinal growth direction, each lumber board of the stack 202 can have a thickness of ⅝-inch to 2-inches (15.88 mm to 50.8 mm) and/or a width of 2.4-inches to 9.5-inches (60.96 mm to 241.3 mm). In some embodiments, the strength-enhanced CLT structure 200 can have a length, L, of at least 6-feet (1.83 m), for example, about 8-feet (2.43 m). Alternatively or additionally, in some embodiments, the strength-enhanced CLT structure 200 can have a width, W, of at least 1-foot (0.30 m), for example, about 2-feet (0.61 m). Alternatively or additionally, in some embodiments, the strength-enhanced CLT structure 200 can have a height, H, of at least 6-inches (15.2 cm), for example, about 8-inches (20.3 cm). Other dimensions are also possible, according to one or more contemplated embodiments. In some embodiments, the lumber boards in each layer can be connected together via joining, for example, finger joints and/or structural adhesive.

The stack 202 can be formed by stacking the lumber boards crosswise at 90-degree angles and glued in place. For example, the outermost lumber boards 208a, 208b can have orientations 210a, 210b that are substantially aligned with each other, and the central lumber board 212 can have an orientation 214 orthogonal to orientations 210a, 210b. In the illustrated example, densified wood panels 204a, 204b can have orientations 206a, 206b that are substantially aligned with each other as well as with orientation 214 of central lumber board 212. Alternatively, in some embodiments, the orientation 206a, 206b of one or both densified wood panels 204a, 204b can be substantially aligned with the orientations 210a, 210b of the outer lumber boards 208a, 208b, or with none of the orientations 210a, 210b, 214 of stack 202. In some embodiments, in addition to the provision of densified wood as top and bottom layers 204a, 204b, additional densified wood can be provided as side layers 204c, 204d (e.g., with orientations 206d that are substantially aligned with each other as well as with orientation 214 of central lumber board 212) so as to enclose stack 202 (e.g., along a circumferential direction), for example, as shown for CLT structure 220 in FIG. 2B. In some embodiments, by employing the densified wood as the top and bottom tension layers, the flatwise bending stiffness of the stack 202 can be improved (e.g., doubled), and/or the spanning capacity of the stack 202 can be increased. Strength-enhanced CLTs, such as CLT structure 200 and/or CLT structure 220, can be used in a broad range of applications, such as but not limited to flooring, walls, and roofing, for example, to replace steel-reinforced concrete in residential and commercial buildings.

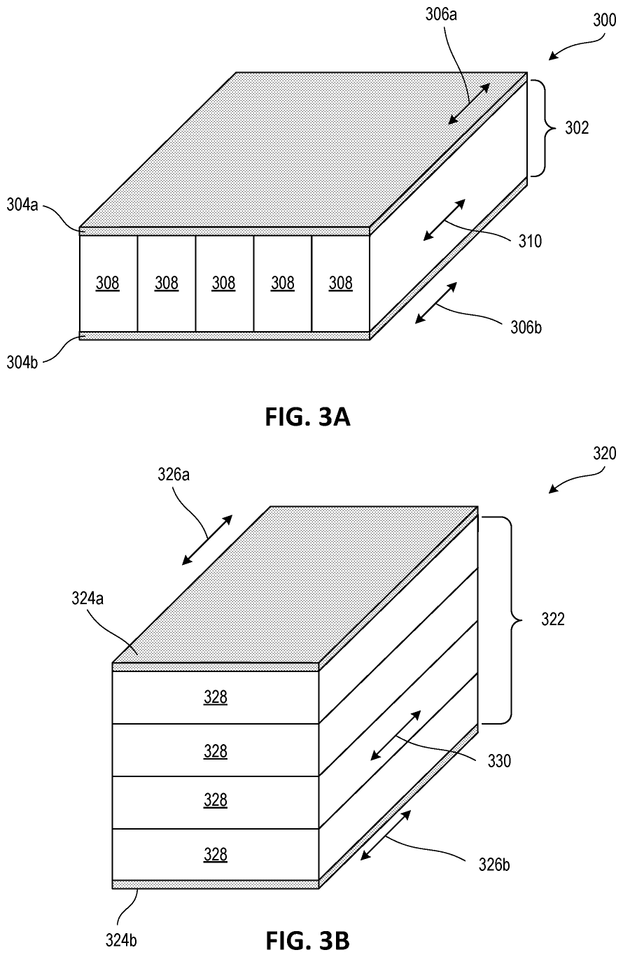

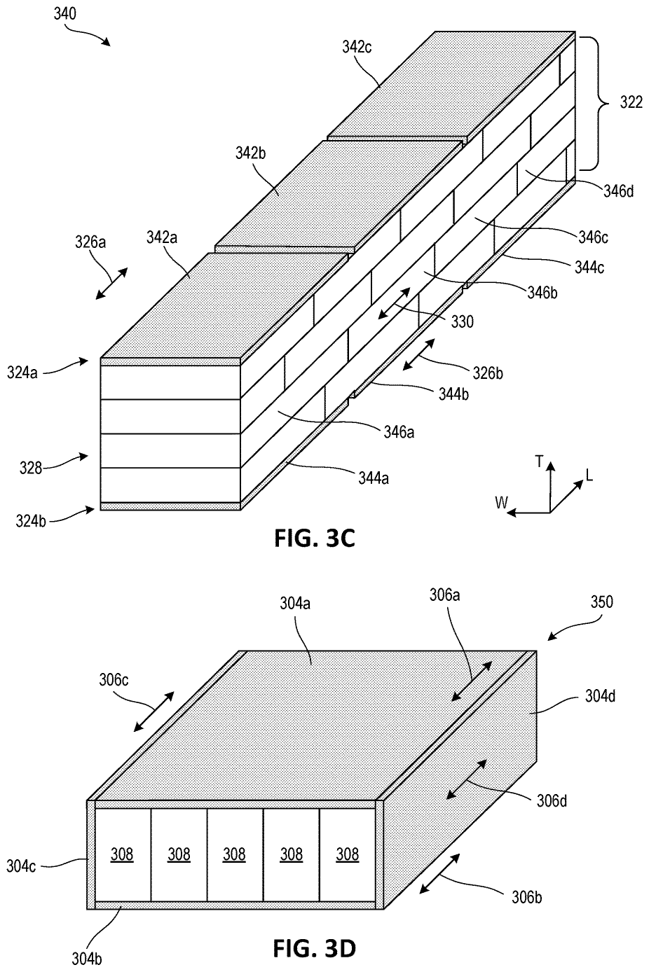

FIG. 3A illustrates a strength-enhanced glued laminated timber (glulam) structure 300 having a laminate structure, with a lateral array 302 of wood layers 308 in between outer layers of densified wood panels 304a, 304b (e.g., having a thickness of 3/16-inch to ¼-inch (4.76 mm to 6.35 mm)). In some embodiments, the array 302 can be a conventional glulam structure. For example, in a cross-sectional plane perpendicular to the respective longitudinal growth direction, each wood panel of the array 302 can have a thickness of 1-inch to 6-inches (2.5 cm to 15.2 cm) and/or a width of 2-inches to 12-inches (5.1 cm to 30.5 cm). Other dimensions are also possible according to one or more contemplated embodiments. In some embodiments, wood segments in each layer can be connected together via joining, for example, finger joints and/or structural adhesive. The array 302 can be formed by arranging individual wood layers 308 (and/or constituent segments thereof) with substantially aligned orientations 310 (e.g., substantially parallel wood fibers) and gluing together. In some embodiments, in addition to the provision of densified wood as top and bottom layers 304a, 304b, additional densified wood can be provided as side layers 304c, 304d to enclose stack 302 (e.g., along a circumferential direction), for example, as shown for glulam structure 350 in FIG. 3D. In the illustrated examples of FIGS. 3A and 3D, densified wood panels 304a-304d can have orientations 306a-306d that are substantially aligned with each other as well as with orientation 310 of the wood layers 308. Alternatively, in some embodiments, the orientations 306a-306d of one, some, or all of densified wood panels 304a-304d can be substantially orthogonal to, or at least crossing with, orientation 310 of the wood layers 308.

FIG. 3B illustrates another strength-enhanced glulam structure 320 that employs a vertical array 322 of wood layers 328 in between outer layers of densified wood panels 324a, 324b (e.g., having a thickness of 3/16-inch to ¼-inch (4.76 mm to 6.35 mm)). Similar to the structure of FIG. 3B, the array 322 can be a conventional glulam structure, for example, with each wood panel of the array 322 having a thickness of 1-inch to 6-inches (2.5 cm to 15.2 cm) and/or a width of 2-inches to 12-inches (5.1 cm to 30.5 cm). Other dimensions are also possible, according to one or more contemplated embodiments. In some embodiments, wood segments in each layer can be connected together via joining, for example, finger joints and/or structural adhesive. The array 322 can be formed by arranging individual wood layers 328 (and/or constituent segments thereof) with substantially aligned orientations 330 (e.g., substantially parallel wood fibers) and gluing together. In the illustrated example, densified wood panels 324a, 324b can have orientations 326a, 326b that are substantially aligned with each other as well as with orientation 330 of the wood layers 328. Alternatively, in some embodiments, the orientations 326a, 326b of one or both densified wood panels 324a, 324b can be substantially orthogonal to, or at least crossing with, orientation 330 of the wood layers 328.

FIG. 3C illustrates another strength-enhanced glulam structure 340 that employs a vertical array 322 of wood layers 328 in between outer layers 324a, 324b of densified wood segments. The top layer 324a can be formed by a plurality of densified wood segments 342a-342c, and the bottom layer 324b can be formed by a plurality of densified wood segments 344a-344c. Similarly, each wood layer 328 of the vertical array 322 can be formed by a plurality of wood segments 346a-346d (which can be offset from each other along the length direction, L, and/or the width direction, W). In some embodiments, wood segments in each layer 324a, 324b, 328 can be connected together via joining, for example, finger joints and/or structural adhesive. In some embodiments, the use of multiple wood segments in each layer can allow the glulam structure 340 to be formed of any length without restriction. In the illustrated example, each top densified wood segment 342a-342c can be substantially aligned (e.g., along the length direction, L, and/or width direction, W) with a corresponding one of the bottom densified wood segments 344a-344c. Alternatively, in some embodiments, the top and bottom densified wood segments can be offset from each other (e.g., in a manner similar to wood segments 346a-346d constituting the wood layers 328 of array 322), for example, to further enhance mechanical stiffness.

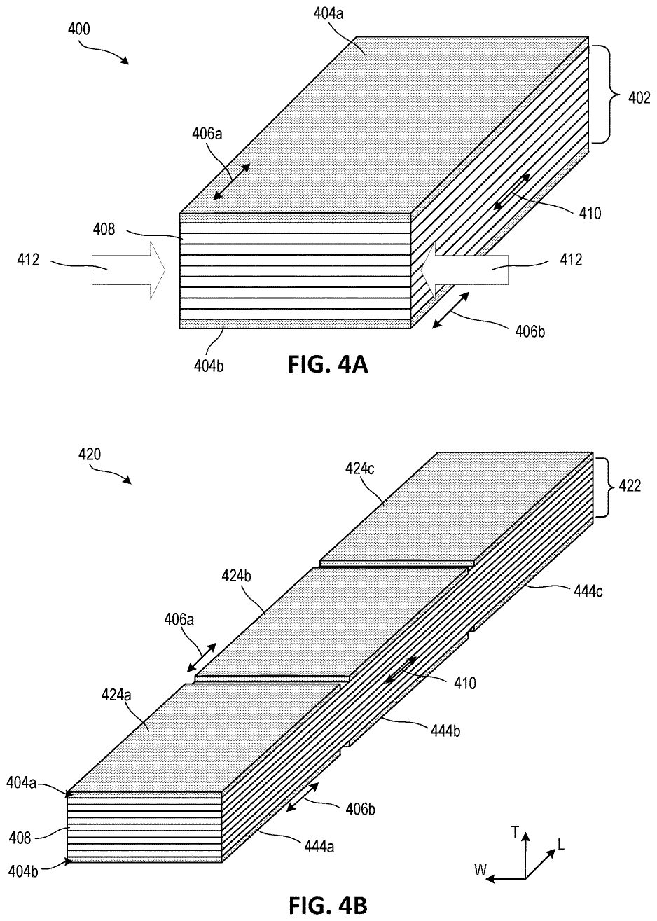

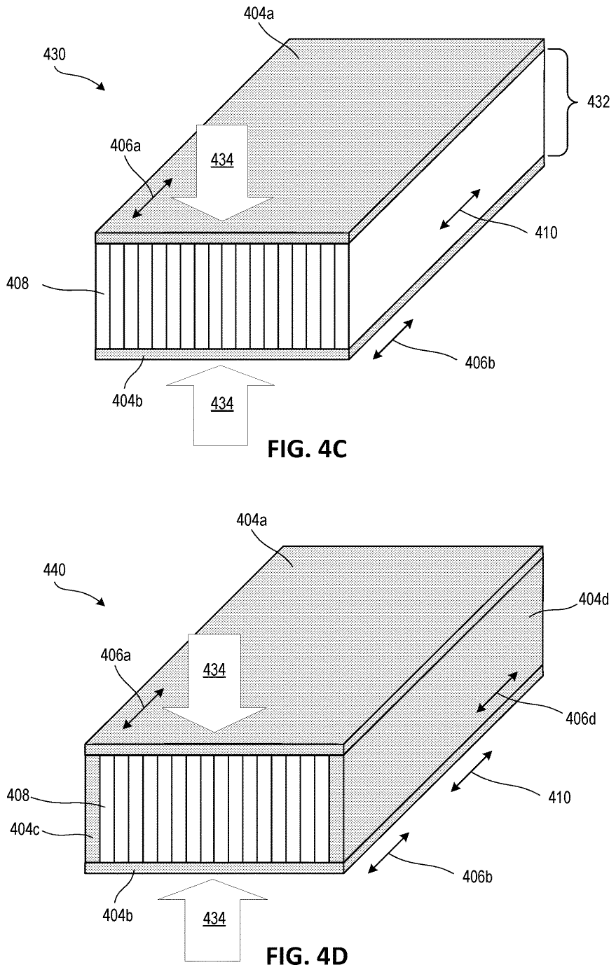

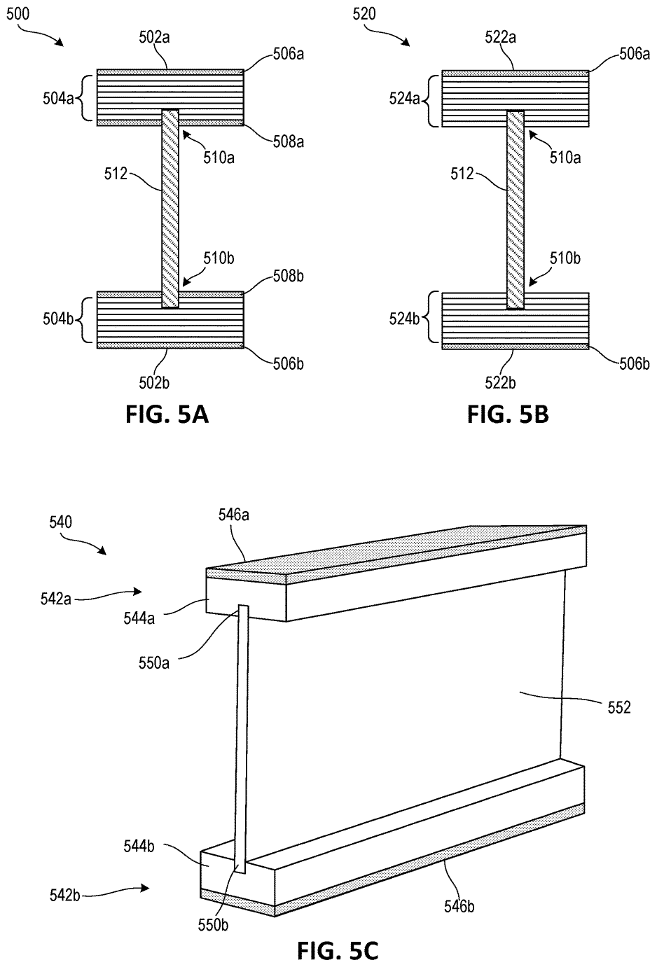

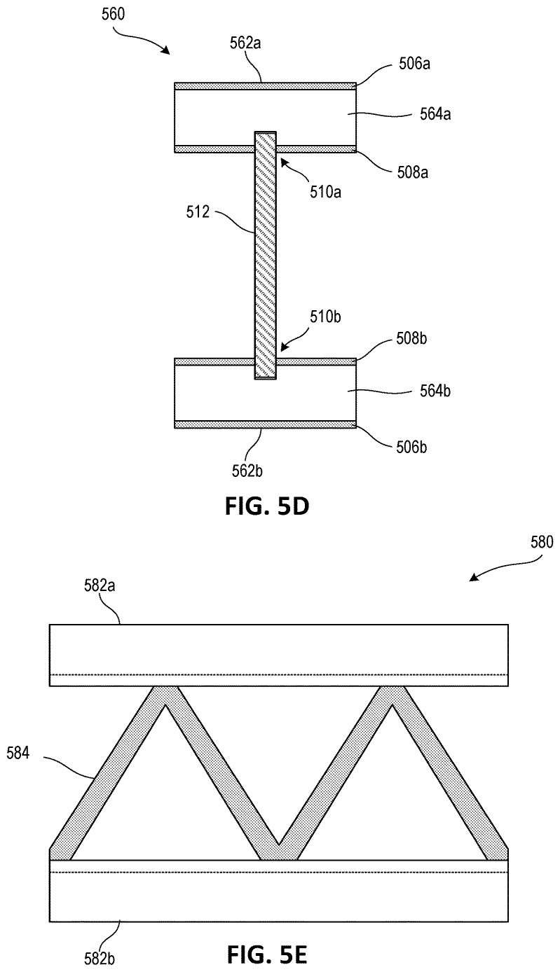

FIG. 4A illustrates a strength-enhanced laminated veneer lumber (LVL) structure 400 having a laminate structure, with a stack 402 of wood veneers 408 in between outer layers of densified wood panels 404a, 404b (e.g., having a thickness of 3/16-inch to ¼-inch (4.76 mm to 6.35 mm)). Alternatively, in some embodiments, one or more densified wood panels can be provided as part of stack 402, for example, in place of, or in addition to, one or more of densified wood panels 404a, 404b. In some embodiments, the stack 402 can be a conventional LVL structure. For example, in a cross-sectional plane perpendicular to the respective longitudinal growth direction, each wood veneer 408 of the stack 402 can have a thickness of 2.5-4.8 mm. Other dimensions are also possible according to one or more contemplated embodiments. The LVL stack 402 can be fabricated, for example, by gluing together (e.g., while pressing) veneers from rotary peeling (e.g., using a peeling lathe). The veneers can be assembled along their longitudinal directions (e.g., with orientations 410 substantially aligned). In the illustrated example, densified wood panels 404a, 404b can have orientations 406a, 406b that are substantially aligned with each other as well as with orientation 410 of wood veneers 408. Alternatively, in some embodiments, the orientations 406a, 406b of one or both densified wood panels 404a, 404b can be substantially orthogonal to, or at least crossing with, orientation 410 of the wood veneers 408. In some embodiments, a load 412 can be applied substantially parallel to a width direction of the strength-enhanced LVL structure 400 and/or substantially perpendicular to a direction in which veneers 408 are stacked (e.g., a height direction of stack 402).

FIG. 4B illustrates another strength-enhanced LVL structure 420 that employs a stack 422 of wood veneers 408 in between outer layers 404a, 404b of densified wood segments. The top layer 404a can be formed by a plurality of densified wood segments 424a-424c, and the bottom layer 404b can be formed by a plurality of densified wood segments 444a-444c. In some embodiments, wood segments in each layer 404a, 404b can be connected together via joining, for example, finger joints and/or structural adhesive. In the illustrated example, each top densified wood segment 424a-424c can be substantially aligned (e.g., along the length direction, L, and/or width direction, W) with a corresponding one of the bottom densified wood segments 444a-444c. Alternatively, in some embodiments, the top and bottom densified wood segments can be offset from each other, for example, to further enhance mechanical stiffness.

FIG. 4C illustrates another strength-enhanced LVL structure 430 having a laminate structure, with a stack 432 of wood veneers 408 in between outer layers of densified wood panels 404a, 404b (e.g., having a thickness of 3/16-inch to ¼-inch (4.76 mm to 6.35 mm)). In the illustrated example of FIG. 4C, the densified wood panels 404a, 404b are provided on opposite sides of stack 432 along a direction substantially perpendicular to a direction in which the wood veneers 408 are stacked. Similar to the structure 400 of FIG. 4A, the stack 432 can be a conventional LVL structure, for example, with each wood veneer 408 of the stack 432 having a thickness of 2.5-4.8 mm in a cross-sectional plane perpendicular to longitudinal growth direction 410; however, other dimensions are also possible according to one or more contemplated embodiments. The LVL stack 432 can be fabricated, for example, by gluing together (e.g., while pressing) veneers from rotary peeling. The veneers can be assembled along their longitudinal directions (e.g., with orientations 410 substantially aligned).

In some embodiments, in addition to the provision of densified wood as top and bottom layers 404a, 404b, additional densified wood can be provided as side layers 404c, 404d to enclose stack 432 (e.g., along a circumferential direction), for example, as shown for LVL structure 440 in FIG. 4D. In the illustrated example, densified wood panels 404a-404d can have orientations 406a-406d that are substantially aligned with each other and parallel to orientation 410 of wood veneers 408. Alternatively, in some embodiments, the orientations 406a-406d of one or both densified wood panels 404a-404d can be substantially orthogonal to, or at least crossing with, orientation 410 of the wood veneers 408. In some embodiments, a load 434 can be applied substantially parallel to a width direction of the strength-enhanced LVL structure 430 or 450 and/or substantially perpendicular to a direction in which veneers 408 are stacked (e.g., a height direction of stack 432). In the illustrated examples of FIGS. 4C-4D, the load 434 can be applied substantially perpendicular to exposed surfaces of densified wood panels 404a, 404b.

In some embodiments, the LVL structure 400, LVL structure 420, LVL structure 430, and/or LVL structure 440 can be employed as part of another engineered structure, for example, in place of one or both outermost layers 304a, 304b of glulam structure 300 in FIG. 3A, in place of one or both outermost layers 324a, 324b of glulam structure 320 in FIG. 3B, in place of one or both outermost layers 324a, 324b of glulam structure 340 in FIG. 3C, in place of one, some, or all of outermost layers 304a-304d of glulam structure 350 in FIG. 3D.

In some embodiments, the LVL structure 400, LVL structure 420, LVL structure 430, and/or LVL structure 440 can be employed as part of the flange of an I-joist. For example, FIG. 5A shows a cross-section of an I-joist 500 that employs strength-enhanced LVL for flanges 502a, 502b. In the illustrated example, top flange 502a has an LVL stack 504a arranged between a pair of densified wood layers 506a, 508a, and bottom flange 502b has an LVL stack 504b arranged between a pair of densified wood layers 506b, 508b. A web 512 can be inserted into respective grooves 510a, 510b in the flanges 502a, 502b and glued thereto (which glue may be the same formulation or a different formulation than that constituting the glue layers of the flange). For example, the web can be formed of plywood, LVL, oriented strand board (OSB), or other engineered wood structure. After assembly, the I-joist 500 can be end-trimmed and heat-cured, or left at room temperature, to reach approximately equilibrium moisture content.

FIG. 5B illustrates another I-joist 520 that employs LVL for the flanges. Similar to FIG. 5A, the web 512 is coupled into respective grooves 510a, 510b and extends between the top and bottom flanges 502a, 502b. However, in contrast to FIG. 5A, the flanges only employ densified wood as outermost layers of the flanges. In the illustrated example, top flange 522a has an LVL stack 524a and a densified wood layer 506a at an end of the LVL stack 524a opposite the web 512, and bottom flange 522b has an LVL stack 524b and a densified wood layer 506b at an end of the LVL stack 524b opposite the web 512.

In some embodiments, the flange of the I-joist can be formed of strength-enhanced solid wood instead of LVL. For example, FIG. 5C illustrates another I-joist 540 that employs strength-enhanced solid wood for flanges 542a, 542b (e.g., having a thickness of 3/16-inch to ¼-inch (4.76 mm to 6.35 mm)). In the illustrated example, top flange 542a has a solid wood panel 544a and a densified wood layer 546a glued to an end of the wood panel 544a opposite the web 552, and bottom flange 542b has a solid wood panel 544b and a densified wood layer 546b glued to an end of the wood panel 544b. The web 552 can be inserted into respective grooves 550a, 550b in the solid wood panels 544a, 544b and glued thereto (which glue may be the same formulation or a different formulation than that constituting the glue layers of the flange). For example, the web 552 can be formed of plywood, LVL, oriented strand board (OSB), or other engineered wood structure. After assembly, the I-joist 540 can be end-trimmed and heat-cured or left at room temperature to reach approximately equilibrium moisture content.

Although FIG. 5C shows strength enhancement via a single layer of densified wood for each flange of the I-joist, embodiments of the disclosed subject matter are not limited thereto. Rather, in some embodiments, multiple densified wood layers can be combined with the solid wood in each flange. For example, FIG. 5D shows a cross-section of another I-joist 560. Similar to the I-joist of FIG. 5A, the web 512 is coupled into respective grooves 510a, 510b and extends between the top and bottom flanges 562a, 562b. However, in contrast to FIG. 5C, the top flange 562a has a solid wood panel 564a arranged between and glued to a pair of densified wood layers 506a, 508a, and bottom flange 562b has a solid wood plane 564b arranged between and glued to a pair of densified wood layers 506b, 508b.

Although the use of densified wood is limited to the flanges of the I-joist in FIGS. 5A-5D, embodiments of the disclosed subject matter are not limited thereto. Rather, in some embodiments, densified wood can be used as part of the web, for example, to allow an open structure for the web. For example, FIG. 5E shows a side view of another I-joist 580 with a mesh 584 extending between the top and bottom flanges 582a, 582b. In the illustrated example, densified wood can be used to form the mesh 584, or as part of an engineered wood structure used to form the mesh 584. For example, the mesh 584 can take the form of a truss or other open structure that is otherwise capable of supporting loads experienced by the I-joist 580. Although the above-description of FIGS. 2A-5E focuses on the use of wood, embodiments of the disclosed subject matter are not limited thereto. Rather, any or all of the above-described wood components can be replaced with other plant materials, according to one or more contemplated embodiments.

### Fabrication Methods

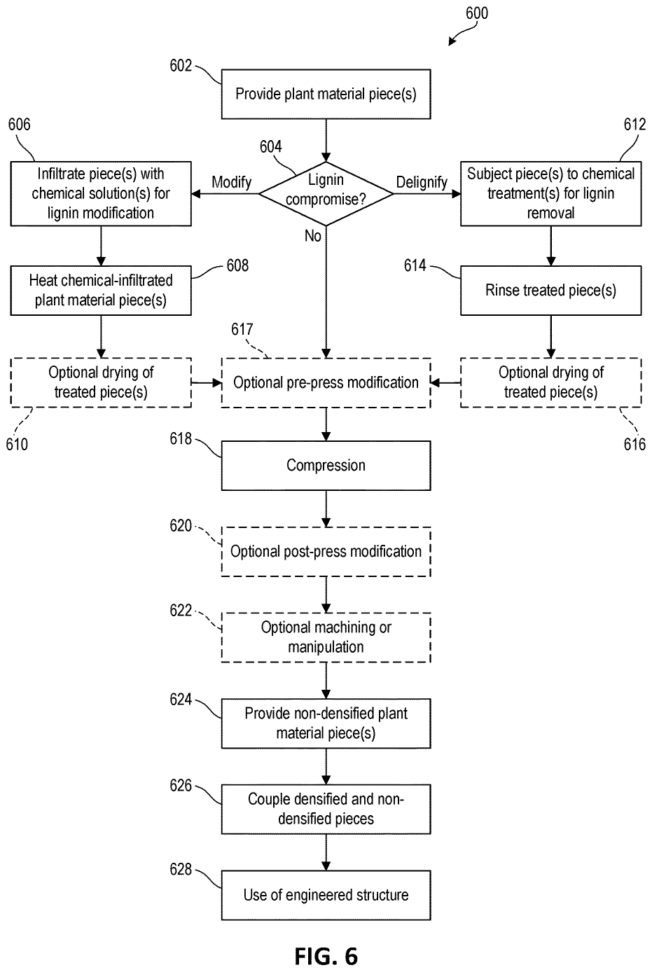

FIG. 6 illustrates aspects of a method 600 for fabricating an engineered structure from one or more plant material pieces. The method 600 can initiate at process block 602, where one or more pieces of natural plant material can be provided. In some embodiments, the provision of process block 602 can include cutting, removing, or otherwise separating the piece from a parent plant (e.g., tree, bamboo stalk, etc.). In some embodiments, the cutting can form the natural plant material into a substantially flat planar structure, with a direction of cellulose fibers extending parallel to a plane of the structure (e.g., longitudinal cut or rotary cut) or extending perpendicular to a plane of the structure (e.g., radial cut). Optionally, in some embodiments, the preparing can include pre-processing of the piece of natural plant material, for example, cleaning to remove any undesirable material or contamination in preparation for subsequent processing, forming the natural plant material into a particular shape in preparation for subsequent processing (e.g., slicing into strips), or any combination of the foregoing. For example, in some embodiments, the cutting can form the plant material piece(s) into any one-dimensional (e.g., an elongated structure, where a thickness and a width are both at least an order of magnitude less than its length), two-dimensional (e.g., a substantially flat planar structure, where a thickness is at least an order of magnitude less than its length and width), or three-dimensional (e.g., a block, where a thickness, width, and length are all within an order of magnitude of each other) structure. In some embodiments, the provision of process block 602 can include assembling multiple plant material pieces into a single layer. Alternatively, in some embodiments, the assembling of multiple plant material pieces into a single layer can occur after processing, for example, after the optional pre-press modification of process block 617 but before the compression of process block 618, or after the compression of process block 618 but before the coupling of process block 626.

The method 600 can proceed to decision block 604, where it is determined if the plant material should be subject to a lignin-compromising treatment. In some embodiments, lignin-compromising may not be desired, for example, where a lower degree of densification is desired for the plant material. In such embodiments, the method 600 can proceed directly from decision block 604 to optional process block 617. Alternatively, if in situ lignin modification is desired at decision block 604, the method 600 can proceed to process block 606, wherein the plant material piece(s) can be infiltrated with one or more chemical solutions to modify lignin therein. For example, in some embodiments, the infiltration can be by soaking the plant material piece(s) in a solution containing the one or more chemicals under vacuum. In some embodiments, the chemical solution can contain at least one chemical component that has OH ions or is otherwise capable of producing OH ions in solution. In some embodiments, one, some, or all of the chemicals in the solution can be alkaline. In some embodiments, the chemical solution includes p-toluenesulfonic acid, NaOH, LiOH, KOH, Na₂O, or any combination thereof. Exemplary combinations of chemicals can include, but are not limited to, p-toluenesulfonic acid, NaOH, NaOH+Na₂SO₃/Na₂SO₄, NaOH+Na₂S, NaHSO₃ +SO₂+H₂O, NaHSO₃ +Na₂SO₃, NaOH+Na₂SO₃, NaOH/NaH₂O₃+AQ, NaOH/Na₂S+AQ, NaOH+Na₂SO₃+AQ, Na₂SO₃+NaOH+CH₃OH+AQ, NaHSO₃+SO₂+AQ, NaOH+Na₂Sx, where AQ is Anthraquinone, any of the foregoing with NaOH replaced by LiOH or KOH, or any combination of the foregoing. In some embodiments, the chemical infiltration can be performed without heating, e.g., at room temperature (20-30 °C, such as ~22-23 °C). In some embodiments, the chemical solution is not agitated in order to avoid disruption to the native cellulose-based microstructure of the plant material piece(s).

For example, in some embodiments, wood can be immersed in a chemical solution (e.g., 2-5% NaOH) in a container. The container can then be placed in a vacuum box and subjected to vacuum. In this way, the air in the wood can be drawn out and form a negative pressure. When the vacuum pump is turned off, the negative pressure inside the wood can suck the solution into the wood through the natural channels therein (e.g., lumina defined by longitudinal cells). The process can be repeated more than once (e.g., 3 times), such that the channels inside the wood can be filled with the chemical solution (e.g., about 2 hours). After this process, the moisture content can increase from ~10.2% (e.g., for natural wood) to ~70% or greater.

The method 600 can proceed to process block 608, where the modification may be activated by subjecting the infiltrated plant material piece(s) to an elevated temperature, for example, greater than 80 °C (e.g., 80 -180 °C, such as 120-160 °C), thereby resulting in softened plant material piece(s) (e.g., softened as compared to the natural plant material piece(s)). In some embodiments, the heating of process block 608 can be achieved via steam heating, for example, via steam generated in an enclosed reactor, via a steam flow in a flow-through reactor, and/or via steam from a superheated steam generator. Alternatively or additionally, in some embodiments, the heating of process block 608 can be achieved via dry heating, for example, via conduction and/or radiation of heat energy from one or more heating elements without separate use of steam. In some embodiments, during process block 608, the infiltrated plant material piece(s) can be subjected to the elevated temperature for a first time period of, for example, 1-5 hours (e.g., depending on the size of the plant material piece, with thicker pieces requiring longer heating times). In some embodiments, after the first time period, any steam generated by heating of the infiltrated plant material piece(s) can be released, for example, by opening a pressure release (e.g., relief valve) of the reactor. For example, in some embodiments, the pressure release can be effective to remove ~50% of moisture in the modified plant material piece(s). For example, in some embodiments, the now softened plant material piece(s) can have a moisture content in a range of 30-50 wt %, inclusive.

The method 600 can proceed from process block 608 to process block 610, where the plant material piece(s) can optionally be dried to reduce the moisture content of the plant material piece(s), for example, without removing too much moisture that the plant material piece lose its softened nature (e.g., such that the moisture content is greater than or equal to ~8-10 wt %). In some embodiments, the optional drying of process block 610 may be effective to reduce a moisture content of the plant material piece(s) from greater than 30 wt % (e.g., 30-50 wt %) to within a range of, for example, 10-20 wt % (e.g., ~15 wt %). While moisture may be removed from the softened plant material piece(s) via the heating of process block 608 and/or the drying (e.g., via evaporation) of process block 610, the removed moisture may be substantially free of residual salts and/or chemicals from the in situ lignin-modification. Rather, in some embodiments, the chemicals can be substantially consumed by the modification, and the residual salts can be retained within the microstructure of the softened plant material piece(s).

If delignification is instead desired at decision block 604, the method 600 can proceed to process block 612, where the plant material piece(s) can be subjected to one or more chemical treatments to remove at least some lignin therefrom, for example, by immersion of the plant material piece(s) (or portion(s) thereof) in a chemical solution associated with the treatment. In some embodiments, each chemical treatment or only some chemical treatments can be performed under vacuum, such that the solution(s) associated with the treatment is encouraged to fully penetrate the cell walls and lumina of the plant material piece(s). Alternatively, in some embodiments, the chemical treatment(s) can be performed under ambient pressure conditions or elevated pressure conditions (e.g., ~6-8 bar). In some embodiments, each chemical treatment or some chemical treatments can be performed at any temperature between ambient (e.g., ~23 °C) and an elevated temperature where the solution associated with the chemical treatment is boiling (e.g., ~70-160 °C). In some embodiments, the solution is not agitated in order to minimize the amount of disruption to the native cellulose-based microstructure of the plant material piece(s).

In some embodiments, the immersion time can be in a range of 0.1 to 96 hours, inclusive, for example, 1-12 hours, inclusive. The amount of time of immersion within the solution may be a function of the amount of lignin to be removed, type of plant material, size of the plant material piece, temperature of the solution, pressure of the treatment, and/or agitation. For example, smaller amounts of lignin removal, smaller plant material piece size (e.g., cross-sectional thickness), higher solution temperature, higher treatment pressure, and agitation may be associated with shorter immersion times, while larger amounts of lignin removal, larger plant material piece size, lower solution temperature, lower treatment pressure, and no agitation may be associated with longer immersion times.

In some embodiments, each chemical treatment of process block 612, or at least one chemical treatment, can comprise infusing, infiltrating, or otherwise exposing the plant material piece(s) to one or more first chemical solutions at a first temperature. In some embodiments, the first chemical solution can be an alkaline solution, and the first temperature can be less than 100 °C. For example, the first temperature can be in a range of 5 -95 °C, inclusive, such as room temperature (e.g., ~23 °C). Alternatively or additionally, the one or more chemical treatments of process block 612 can include partially or fully immersing the plant material piece(s) in a second chemical solution at a second temperature greater than the first temperature. Alternatively or additionally, at least one chemical treatment can comprise infusing, infiltrating, or otherwise exposing the plant material to the second chemical solution at the second temperature. In some embodiments, the second chemical solution can be an alkaline solution, and the second temperature can be greater than 100 °C. For example, the second temperature can be in a range of 120-180 °C, such as 160 °C. For example, the temperature of the chemical solution can be increased to 50-180 °C for 0.1~10 h to remove 5-95% lignin and hemicellulose from the plant material piece(s). In some embodiments, the second chemical solution may be the same solution as the first chemical solution. In such cases, the first chemical solution can be heated from the first temperature to the second temperature while the plant material piece remains therein. Alternatively, in some embodiments, a composition of the second chemical solution can be identical to a composition of the first chemical solution, for example, by providing a fresh batch of solution for use as the second chemical solution (e.g., by removing the plant material piece(s) from the first chemical solution and immersing in the second chemical solution, or by draining the first chemical solution and replacing with fresh second chemical solution). Alternatively, in some embodiments, a composition of the second chemical solution can be different from the composition of the first chemical solution.

In some embodiments, the solution of the chemical treatment(s) can include sodium hydroxide (NaOH), lithium hydroxide (LiOH), potassium hydroxide (KOH), sodium sulfite (Na₂SO₃), sodium sulfide (Na₂S), NaₙS (where n is an integer), urea (CH₄N₂O), sodium bisulfite (NaHSO₃), sulfur dioxide (SO₂), anthraquinone (AQ) (C₁₄H₈O₂), methanol (CH₃OH), ethanol (C₂H₅OH), butanol (C₄H₉OH), formic acid (CH₂O₂), hydrogen peroxide (H₂O₂), acetic acid (CH₃COOH), butyric acid (C₄H₈O₂), peroxyformic acid (CH₂O₃), peroxyacetic acid (C₂H₄O₃), ammonia (NH₃), tosylic acid (p-TsOH), sodium hypochlorite (NaClO), sodium chlorite (NaClO₂), chlorine dioxide (ClO₂), chlorine (Cl₂), or any combination of the above. Exemplary combinations of chemicals for the chemical treatment can include, but are not limited to, NaOH+Na₂SO₃, NaOH+Na₂S, NaOH+urea, NaHSO₃+SO₂+H₂O, NaHSO₃+Na₂SO₃, NaOH+Na₂SO₃, NaOH+AQ, NaOH+Na₂S+AQ, NaHSO₃+SO₂+H₂O+AQ, NaOH+Na₂SO₃+AQ, NaHSO₃+AQ, NaHSO₃+Na₂SO₃+AQ, Na₂SO₃+AQ, NaOH+Na₂S+NaₙS (where n is an integer), Na₂SO₃+NaOH+CH₃OH+AQ, C₂H₅OH+NaOH, CH₃OH+HCOOH, NH₃+H₂O, and NaClO₂ +acetic acid. For example, the first and second chemical solutions can be ≤2 wt % NaOH and Na₂SO₃ (e.g., formed by adding H₂SO₃ acid to NaOH).

The chemical treatment can continue (or can be repeated with subsequent solutions) until a desired reduction in lignin content in the plant material piece is achieved. In some embodiments, the lignin content can be reduced to between 0.1% (lignin content is 0.1% of original lignin content in the natural plant material) and 99% (lignin content is 99% of original lignin content in the natural plant material). In some embodiments, the chemical treatment reduces the hemicellulose content at the same time as the lignin content, for example, to the same or lesser extent as the lignin content reduction. In some embodiments, when the plant material piece is hardwood, the lignin content after the chemical treatment(s) of process block 612 can be at least 10 wt % (e.g., in a range of 10-15 wt %, inclusive). In some embodiments, when the plant material piece is softwood, the lignin content after the chemical treatment(s) of process block 612 can be at least 12.5 wt % (e.g., 12.5-17.5 wt %, inclusive). In some embodiments, when the plant material piece is bamboo, the lignin content after the chemical treatment(s) of process block 612 can be at least 13 wt % (e.g., 13-18 wt %, inclusive).

The method 600 can proceed from process block 612 to process block 614, where rinsing can be performed. For example, the rinsing can be used to remove residual chemicals or particulate(s) resulting from the chemical treatment(s). For example, the delignified plant material piece(s) can be partially or fully immersed in one or more rinsing solutions. The rinsing solution can be a solvent, such as but not limited to, de-ionized (DI) water, alcohol (e.g., ethanol, methanol, isopropanol, etc.), or any combination thereof. For example, the rinsing solution can be formed of equal volumes of water and ethanol. In some embodiments, the rinsing can be performed without agitation, for example, to avoid disruption of the microstructure. In some embodiments, the rinsing may be repeated multiple times (e.g., at least 3 times) using a fresh mixture rinsing solution for each iteration, or until a substantially neutral pH is measured for the chemically-treated plant material piece(s).

The method 600 can proceed to optional process block 616, where the chemically-treated plant material piece(s) can be dried, for example, such that the moisture content therein is less than 15 wt % (e.g., 8-12 wt %). The drying of either process block 610 or process block 616 can include any of conductive, convective, and/or radiative heating processes, including but not limited to an air-drying process, a vacuum-assisted drying process, an oven drying process, a freeze-drying process, a critical point drying process, a microwave drying process, or any combination of the above. For example, an air-drying process can include allowing the processed plant material piece(s) to naturally dry in static or moving air, which air may be at any temperature, such as room temperature (e.g., 23 ° C) or at an elevated temperature (e.g., greater than 23 °C). For example, a vacuum-assisted drying process can include subjecting the processed plant material piece(s) to reduced pressure, e.g., less than 1 bar, for example, in a vacuum chamber or vacuum oven. For example, an oven drying process can include using an oven, hot plate, or other conductive, convective, or radiative heating apparatus to heat the processed plant material piece(s) at an elevated temperature (e.g., greater than 23 °C), for example, 70 °C or greater. For example, a freeze-drying process can include reducing a temperature of the processed plant material piece(s) to below a freezing point of the fluid therein (e.g., less than 0 °C), then reducing a pressure to allow the frozen fluid therein to sublime (e.g., less than a few millibars). For example, a critical point drying process can include immersing the processed plant material piece(s) in a fluid (e.g., liquid carbon dioxide), increasing a temperature and pressure of the plant material piece(s) past a critical point of the fluid (e.g., 7.39 MPa, 31.1 °C for carbon dioxide), and then gradually releasing the pressure to remove the now gaseous fluid. For example, a microwave drying process can include using a microwave oven or other microwave generating apparatus to induce dielectric heating within the processed plant material piece(s) by exposing it to electromagnetic radiation having a frequency in the microwave regime (e.g., 300 MHz to 300 GHz), for example, a frequency of ~915 MHz or ~2.45 GHz.

After optional process block 610 or optional process block 616, or if no lignin compromising treatment is desired at decision block 604, the method 600 can proceed to process block 617, where the processed plant material piece(s) can optionally be subjected to one or more internal modifications prior to pressing. Although the term “internal” is used to refer to the modification of process block 617, it is contemplated that, in some embodiments, the modification may be applied to external features as well as internal features of the processed plant material piece(s), while in other embodiments the modification may be applied to either internal features or external features of the processed plant material piece(s) without otherwise affecting the other feature. In some embodiments, the internal modification can include forming, depositing, or otherwise providing non-native particles on surfaces of the processed plant material piece(s). Such surfaces can include at least internal surfaces, e.g., cell walls lining the lumina, but may also include external surfaces of the processed plant material piece(s). The non-native particles incorporated onto the surfaces of the processed plant material piece(s) can imbue the final structure with certain advantageous properties, such as hydrophobicity, weatherability, corrosion resistance (e.g., salt water resistant), and/or flame resistance among other properties. For example, in some embodiments, hydrophobic nanoparticles (e.g., SiO₂ nanoparticles) can be formed on surfaces of the processed plant material piece(s).

Alternatively or additionally, in some embodiments, the internal modification can include performing a further chemical treatment that modifies the surface chemistry of the processed plant material piece(s). For example, in some embodiments, the further chemical treatment can provide weatherability or corrosion resistance can include at least one of cupramate (CDDC), ammoniacal copper quaternary (ACQ), chromated copper arsenate (CCA), ammoniacal copper zinc arsenate (ACZA), copper naphthenate, acid copper chromate, copper citrate, copper azole, copper 8-hydroxyquinolinate, pentachlorophenol, zinc naphthenate, copper naphthenate, creosote, titanium dioxide, propiconazole, tebuconazole, cyproconazole, boric acid, borax, organic iodide (IPBC), and Na₂B₈O₁₃·4H₂O.

Alternatively or additionally, in some embodiments, the internal modification of process block 617 can include infiltrating the processed plant material piece(s) with one or more polymers (or polymer precursors). For example, the processed plant material piece(s) can be immersed in a polymer solution under vacuum to form a hybrid material. The polymer can be any type of polymer capable of infiltrating into the pores of the processed plant material piece(s), for example, a synthetic polymer, a natural polymer, a thermosetting polymer, or a thermoplastic polymer. For example, in some embodiments, the polymer can be epoxy resin, polyvinyl alcohol (PVA), polyethylene glycol (PEO), polyamide (PA), polyethylene terephthalate (PET), polybutylene terephthalate (PBT), polytrimethylene terephthalate (PTT), polyacrylonitrile (PAN), polycaprolactam (PA6), poly(m-phenylene isophthalamide) (PMIA), poly-p-phenylene terephthalamide (PPTA), polyurethane (PU), polycarbonate (PC), polypropylene (PP), high-density polyethylene (HDPE), polystyrene (PS), polycaprolactone (PCL), polybutylene succinate (PBS), polybutylene adipate terephthalate (PBAT), poly(butylene succinate-co-butylene adipate) (PBSA), polyhydroxybutyrate (PHB), poly(3-hydroxybutyrate-co-3-hydroxyvalerate) (PHBV), poly(glycolic acid) (PGA), polypyrrole (PPy), polythiophene (PTh), polyvinylidene fluoride (PVDF), polyvinyl fluoride (PVF), ethylene vinyl alcohol (EVOH), poly(vinylidene chloride) (PVDC), polyxylylene adipamide (MXD6), polyethylene (PE), polyvinyl chloride (PVC), poly(methyl methacrylate) (PMMA), acrylonitrile butadiene styrene (ABS), polyimide (PI), polyethylenimine (PEI), polylactic acid (PLA), octadecyl trichlorosilane (OTS), polyoctahedral silsesquioxane (POSS), paramethylstyrene (PMS), polydimethylsiloxane (PDMS), poly(ethylene naphthalate (PEN), a graft copolymer of acrylonitrile-butadiene-styrene-methylmethacrylate (ABSM), dodecyltrimethoxysilane (DTMS), rosin, chitin, chitosan, protain, plant oil, lignin, hemicellulose, carboxymethyl cellulose, cellulose acetate, starch, agar, or any combination of the above.

The method 600 can proceed to process block 618, where the processed plant material piece is pressed in a direction crossing its longitudinal direction. In some embodiments, the pressing can be in a direction substantially perpendicular to the longitudinal direction, while in other embodiments the pressing may have a force component perpendicular to the longitudinal direction. In either case, the pressing can be effective to reduce a thickness of the processed plant material piece(s), thereby increasing its density as well as collapsing (at least partially) the natural lumina (e.g., vessels, lumen in each fiber, parenchyma cells, etc.), voids, and/or gaps within the cross-section of the processed plant material piece(s). In some embodiments, the pressing can be along a single direction (e.g., along radial direction R), for example, to reduce a thickness of the processed plant material piece(s) (e.g., at least a 5:2 reduction in dimension as compared to the plant material piece(s) prior to pressing). Alternatively or additionally, in some embodiments, the processed plant material piece(s) can be simultaneously pressed in two directions (e.g., along radial direction R and a second direction perpendicular to both the radial direction R and the longitudinal direction L), for example, to reduce a cross-sectional area of the plant material piece(s) (e.g., to produce a densified rectangular bar). Alternatively or additionally, in some embodiments, the processed plant material piece(s) can be sequentially pressed in different directions (e.g., first along radial direction R and then along a second direction perpendicular to the radial direction R and longitudinal direction L).

In some embodiments, the pressing may be performed without any prior drying of the plant material piece(s) or with the plant material piece(s) retaining at least some water or other fluid therein. The pressing can thus be effective to remove at least some water or other fluid from the plant material piece(s) at the same time as its dimension is reduced and density increased. In some embodiments, a separate drying process can be combined with the pressing process. For example, the plant material piece(s) may initially be pressed to cause densification and remove at least some water or fluid therefrom, followed by a drying process (e.g., air drying) to remove the remaining water or fluid. Alternatively, in some embodiments, the plant material piece(s) may initially be dried to remove at least some water or fluid therefrom (e.g., initial drying in a humidity chamber followed by air drying at room temperature, such that the moisture content of the plant material piece(s) approaches but remains greater than 15 wt %, for example, 10 wt %), followed by pressing to cause densification (and potentially further removal of water or other fluid, for example, a moisture content less than 10 wt %, such as 3-8 wt %).

In some embodiments, the pressing can encourage hydrogen bond formation between the cellulose-based fibers of the cell walls of the plant material piece(s), thereby improving mechanical properties of the plant material piece. Moreover, any particles or materials formed on surfaces of the plant material piece(s) or within the plant material piece(s) (e.g., via the optional modification of process block 617) can be retained after the pressing, with the particles/materials on internal surfaces being embedded within the collapsed lumina and intertwined cell walls.

The pressure and timing of the pressing can be a factor of the size of plant material piece(s) prior to pressing, the desired size of the plant material piece(s) after pressing, the water or fluid content within the plant material piece(s) (if any), the temperature at which the pressing is performed, relative humidity, the characteristics of material (e.g., infiltrated polymer) from the internal modification (if any), and/or other factors. For example, the plant material piece(s) can be held under pressure for a time period of 1 minute up to several hours (e.g., 1-180 minutes, inclusive). In some embodiments, the plant material piece(s) can be held under pressure for 3-72 hours, inclusive. In some embodiments, the pressing can be performed at a pressure between 0.5 MPa and 20 MPa, inclusive, for example, 5 MPa. In some embodiments the pressing may be performed without heating (e.g., cold pressing), while in other embodiments the pressing may be performed with heating (e.g., hot pressing). For example, the pressing may be performed at a temperature between 20 °C and 160 °C, e.g., greater than or equal to 100 °C. In some embodiments, the pressing can be effective to fully collapse the lumina of the native cellulose-based microstructure of the plant material and/or can result in a density for the compressed plant material of at least 1.15 g/cm³ (e.g., ≥1.2 g/cm³ or ≥1.3 g/cm³, for example, in a range of 1.4-1.5 g/cm³).

The method 600 can proceed to process block 620, where the now-densified plant material piece(s) may optionally be subjected to an external modification. Although the term “external” is used to refer to the optional modification of process block 620, it is contemplated that, in some embodiments, the modification may be applied to internal features as well as external features of the densified plant material piece(s), while in other embodiments the modification may be applied to either internal features or external features of the densified plant material piece(s) without otherwise affecting the other feature. In some embodiments, the external modification can include forming, depositing, or otherwise providing a coating on one or more external surfaces of the densified plant material piece(s). The coating may imbue the densified plant material piece(s) with certain advantageous properties, such as but not limited to hydrophobicity, weatherability, corrosion resistance (e.g., salt water resistant), and/or flame resistance. For example, the coating can comprise an oil-based paint, a hydrophobic paint, a polymer coating, and/or a fire-resistant coating. In some embodiments, the fire-resistant coating can include nanoparticles (e.g., boron nitride nanoparticles). Alternatively or additionally, in some embodiments, a coating for the densified plant material piece(s) can include boron nitride (BN), montmorillonite clay, hydrotalcite, silicon dioxide (SiO₂), sodium silicate, calcium carbonate (CaCO₃), aluminum hydroxide (Al(OH)₃), magnesium hydroxide (Mg(OH)₂), magnesium carbonate (MgCO₃), aluminum sulfate, iron sulfate, zinc borate, boric acid, borax, triphenyl phosphate (TPP), melamine, polyurethane, ammonium polyphosphate, phosphate, phosphite ester, ammonium phosphate, ammonium sulfate, phosphonate, diammonium phosphate (DAP), ammonium dihydrogen phosphate, monoammonium phosphate (MAP), guanylurea phosphate (GUP), guanidine dihydrogen phosphate, antimony pentoxide, or any combination of the above.

The method 600 can proceed to process block 622, where the densified plant material piece(s) can optionally be machined, cut, and/or otherwise physically manipulated in preparation for eventual use. Machining processes can include, but are not limited to, cutting (e.g., sawing), drilling, woodturning, tapping, boring, carving, routing, sanding, grinding, and abrasive tumbling. Manipulating process can include, but are not limited to, bending, molding, and other shaping techniques. In some embodiments, the manipulating can include assembling multiple processed plant material pieces into a single layer. For example, in some embodiments, processed plant material strands can be mixed with a waterproof resin and interleaved together to form a mat, which can then be subjected to heat and/or pressure to bond the strands and resin together.

The method 600 can proceed to process block 624, where one or more non-densified plant material pieces can be provided. In some embodiments, the provision of process block 624 can be similar to the provision of process block 602. For example, the plant material of the non-densified pieces can be the same type of plant material or a different type of plant material as that used in process block 602. In some embodiments, the non-densified plant material pieces can have a density less than 1.15 g/cm³ (e.g., ≤1.0 g/cm³ or ≤0.9 g/cm³, for example, in a range of 0.1-0.9 g/cm³). In some embodiments, the provision of process block 624 can include machining, cutting, or otherwise physically manipulating, for example, to form a layer of appropriate size for a desired configuration of the engineered structure. For example, the number of non-densified plant material pieces (or non-densified plant material layers) can be greater than the number of densified plant material pieces (or densified plant material layers), such as at least two times greater.

The method 600 can proceed to process block 626, where the non-densified and densified plant material pieces can be coupled together (e.g., via glue or other adhesive layer) to form an engineered structure. In some embodiments, process block 626 can include layering, aligning, or otherwise positioning the non-densified and densified plant material pieces with respect to each other. In some embodiments, the non-densified plant material pieces and/or the densified plant material pieces can be coupled together using epoxy, polyurethane adhesive, polyvinyl acetate-isocyanate adhesive, resorcinol formaldehyde resin adhesive, phenolic resin, and/or sodium carboxymethyl cellulose (CMC). In some embodiments, the coupling of non-densified and densified plant material pieces can form a laminated structure or portion thereof, for example, any of the engineered structures illustrated in FIGS. 1A-5E.

The method 600 can proceed to process block 628, where the engineered structure formed from densified and non-densified plant material pieces can be used in a particular application. For example, the engineered structure can be adapted for use as structural material (e.g., a load bearing component or a non-load bearing component). One of ordinary skill in the art will readily appreciate that the engineered structures disclosed herein can be readily adapted for use in various applications based on the teachings of the present disclosure.

Although blocks 602-628 of method 600 have been described as being performed once, in some embodiments, multiple repetitions of a particular process block may be employed before proceeding to the next decision block or process block. In addition, although blocks 602-628 of method 600 have been separately illustrated and described, in some embodiments, process blocks may be combined and performed together (simultaneously or sequentially). Moreover, although FIG. 6 illustrates a particular order for blocks 602-628, embodiments of the disclosed subject matter are not limited thereto. Indeed, in certain embodiments, the blocks may occur in a different order than illustrated or simultaneously with other blocks. In some embodiments, method 600 can include steps or other aspects not specifically illustrated in FIG. 6. Alternatively or additionally, in some embodiments, method 600 may comprise only some of blocks 602-628 of FIG. 6.

### Additional Examples of the Disclosed Technology

In view of the above-described implementations of the disclosed subject matter, this application discloses the additional examples in the clauses enumerated below. It should be noted that one feature of a clause in isolation, or more than one feature of the clause taken in combination, and, optionally, in combination with one or more features of one or more further clauses are further examples also falling within the disclosure of this application.
Clause 1. An engineered structure comprising:
a first laminate comprising a plurality of constituent plant material layers, the plurality of constituent plant material layers comprising one or more first layers and one or more second layers, each plant material layer being adhered to an adjacent plant material layer via one or more respective glues,
wherein each first plant material layer is a densified plant material layer having a density greater than or equal to 1.15 g/cm³ and a mechanical strength greater than or equal to a first value, and
each second plant material layer is a plant material layer having a density less than 1.15 g/cm³ and a mechanical strength less than the first value.
Clause 2. The engineered structure of any clause or example herein, in particular, Clause 1, wherein the plant material forming one, some, or all of the constituent layers in the first laminate is a wood or bamboo.
Clause 3. The engineered structure of any clause or example herein, in particular, any one of Clauses 1-2, wherein the densified plant material forming one, some, or all of the one or more first layers is a densified wood or densified bamboo.
Clause 4. The engineered structure of any clause or example herein, in particular, any one of Clauses 1-3, wherein the plant material forming one, some, or all of the one or more second layers is a native wood or native bamboo.
Clause 5. The engineered structure of any clause or example herein, in particular, any one of Clauses 1-4, wherein the plant material forming one, some, or all of the one or more first layers is the same plant material as that of one, some, or all of the one or more second layers.
Clause 6. The engineered structure of any clause or example herein, in particular, any one of Clauses 1-5, wherein the plant material forming one, some, or all of the one or more first layers is a different plant material from that of one, some, or all of the one or more second layers.
Clause 7. The engineered structure of any clause or example herein, in particular, any one of Clauses 1-6, wherein:
(a1) the density of one, some, or all of the one or more first layers is greater than or equal to 1.2 g/cm³;
(a2) the density of one, some, or all of the one or more second layers is less than or equal to 1.0 g/cm³; or
both (a1) and (a2).
Clause 8. The engineered structure of any clause or example herein, in particular, any one of Clauses 1-7, wherein:
(a3) the density of one, some, or all of the one or more first layers is greater than or equal to 1.3 g/cm³;
(a4) the density of one, some, or all of the one or more second layers is less than or equal to 0.9 g/cm³; or
both (a3) and (a4).
Clause 9. The engineered structure of any clause or example herein, in particular, any one of Clauses 1-8, wherein one, some, or all of the one or more second layers comprises one or more pieces of non-densified plant material that retains a native microstructure of cellulose-based lumina of the plant material.
Clause 10. The engineered structure of any clause or example herein, in particular, any one of Clauses 1-9, wherein one, some, or all of the one or more first layers comprises one or more pieces of densified plant material, with cellulose-based lumina of a native microstructure of the plant material being substantially collapsed.
Clause 11. The engineered structure of any clause or example herein, in particular, any one of Clauses 1-10, wherein one, some, or all of the one or more first layers comprises lignin-compromised plant material.
Clause 12. The engineered structure of any clause or example herein, in particular, Clause 11, wherein the lignin-compromised plant material comprises modified lignin therein, and the modified lignin has shorter macromolecular chains than that of native lignin in the natural plant material.
Clause 13. The engineered structure of any clause or example herein, in particular, Clause 12, wherein a content of the modified lignin in the one, some, or all of the one or more first layers is at least 90%, on a weight percentage basis, of a content of the native lignin in the natural plant material.
Clause 14. The engineered structure of any clause or example herein, in particular, any one of Clauses 12-13, wherein a content of the modified lignin in the one, some, or all of the one or more first layers is at least 20 wt %.
Clause 15. The engineered structure of any clause or example herein, in particular, any one of Clauses 12-14, wherein the one, some, or all of the one or more first layers comprises a salt of an alkaline chemical immobilized within a cellulose-based microstructure of the lignin-compromised plant material.
Clause 16. The engineered structure of any clause or example herein, in particular, Clause 15, wherein the salt is substantially pH-neutral.
Clause 17. The engineered structure of any clause or example herein, in particular, Clause 11, wherein the lignin-compromised plant material comprises at least partially delignified wood.
Clause 18. The engineered structure of any clause or example herein, in particular, Clause 17, where a lignin content of the at least partially delignified plant material is between 5% and 95%, inclusive, of a lignin content of the natural plant material.
Clause 19. The engineered structure of any clause or example herein, in particular, any one of Clauses 17-18, wherein:
the plant material is a hardwood or bamboo, and a lignin content of the at least partially delignified plant material is between 0.9 wt % and 23.8 wt %, inclusive; or
the plant material is a softwood, and a lignin content of the at least partially delignified plant material is between 1.25 wt % and 33.25 wt %, inclusive.
Clause 20. The engineered structure of any clause or example herein, in particular, any one of Clauses 17-19, wherein a lignin content of the at least partially delignified plant material is at least 10 wt %.
Clause 21. The engineered structure of any clause or example herein, in particular, any one of Clauses 1-20, wherein:
(a5) each first layer consists essentially of densified plant material;
(a6) each second layer consists essentially of non-densified wood; or
both (a5) and (a6).
Clause 22. The engineered structure of any clause or example herein, in particular, any one of Clauses 1-21, wherein the one or more respective glues comprise epoxy, polyurethane adhesive, polyvinyl acetate-isocyanate adhesive, resorcinol formaldehyde resin adhesive, phenolic resin, sodium carboxymethyl cellulose (CMC), or any combination of the foregoing.
Clause 23. The engineered structure of any clause or example herein, in particular, any one of Clauses 1-22, wherein:
one, some, or all of the one or more first layers is formed from a wood species that is the same as that of one, some, or all of the one or more second layers; or
one, some, or all of the one or more first layers is formed from a wood species that is different from that of one, some, or all of the one or more second layers.
Clause 24. The engineered structure of any clause or example herein, in particular, any one of Clauses 1-23, wherein one, some, or all of the one or more first layers is disposed within the first laminate at a respective location where the first laminate experiences a highest stress.
Clause 25. The engineered structure of any clause or example herein, in particular, any one of Clauses 1-24, wherein one, some, or all of the one or more first layers is disposed as a respective outermost layer of the first laminate.
Clause 26. The engineered structure of any clause or example herein, in particular, any one of Clauses 1-25, wherein the one or more first layers encloses the one or more second layers in a cross-sectional view.
Clause 27. The engineered structure of any clause or example herein, in particular, any one of Clauses 1-26, wherein the one or more first layers fully encloses the one or more second layers on all sides.
Clause 28. The engineered structure of any clause or example herein, in particular, any one of Clauses 1-27, wherein:
the second layers comprise a stack of plant material boards arranged such that adjacent plant material boards have orthogonal orientations, and
the stack of plant material boards is disposed between a pair of the first layers so as to form a reinforced cross-laminated timber (CLT) structure.
Clause 29. The engineered structure of any clause or example herein, in particular, any one of Clauses 1-28, wherein the first laminate comprises a plurality of the second layers and a pair of first layers, each second layer comprising one or more plant material segments, the second layers being arranged in a stack such that adjacent second layers have parallel orientations, the stack being disposed between the pair of first layers so as to form a reinforced glued laminated (glulam) structure.
Clause 30. The engineered structure of any clause or example herein, in particular, any one of Clauses 1-28, wherein the first laminate comprises a plurality of the second layers and a pair of first layers, each second layer comprising one or more plant material veneers, the second layers being arranged in a stack such that adjacent second layers have parallel orientations, the stack being disposed between the pair of first layers so as to form a reinforced laminated veneer lumber (LVL) structure.
Clause 31. The engineered structure of any clause or example herein, in particular, any one of Clauses 1-30, further comprising:
a second laminate comprising a second plurality of constituent plant material layers, the second plurality of constituent plant material layers comprising one or more third layers and one or more fourth layers, each plant material layer being adhered to an adjacent plant material layer via one or more respective glues; and
a web extending between the first and second laminates,
wherein each third layer is a densified plant material layer having a density greater than or equal to 1.15 g/cm³ and a mechanical strength greater than or equal to a second value,
each fourth layer is a plant material layer having a density less than 1.15 g/cm³ and a mechanical strength less than the second value,
the web and the first and second laminates together form an I-joist, and
the first and second laminates form first and second flanges, respectively, of the I-joist.
Clause 32. The engineered structure of any clause or example herein, in particular, Clause 31, wherein the web comprises one or more pieces of non-densified plant material that retains a native microstructure of cellulose-based lumina of the plant material.
Clause 33. The engineered structure of any clause or example herein, in particular, any one of Clauses 31-32, wherein the web comprises one or more pieces of densified plant material, with cellulose-based lumina of a native microstructure of the plant material being substantially collapsed.
Clause 34. The engineered structure of any clause or example herein, in particular, any one of Clauses 31-33, wherein the plant material forming one, some, or all of the constituent layers in the second laminate is a wood or bamboo.
Clause 35. The engineered structure of any clause or example herein, in particular, any one of Clauses 31-34, wherein:
(a7) the plant material forming one, some, or all of the one or more third layers is a densified wood or densified bamboo;
(a8) the plant material forming one, some, or all of the one or more fourth layers is a native wood or native bamboo; or
both (a7) and (a8).
Clause 36. The engineered structure of any clause or example herein, in particular, any one of Clauses 31-35, wherein one of the one or more first layers forms an exposed side of the first flange opposite the web, and/or one of the one or more third layers forms an exposed side of the second flange opposite the web.
Clause 37. The engineered structure of any clause or example herein, in particular, any one of Clauses 31-35, wherein:
(a9) one of the one or more second layers forms an exposed side of the first flange opposite the web, and one of the one or more first layers is disposed within the first flange between the exposed side of the first flange and the web;
(a10) one of the one or more fourth layers forms an exposed side of the second flange opposite the web, and one of the one or more third layers is disposed within the second flange between the exposed side of the second flange and the web; or
both (a9) and (b10).
Clause 38. The engineered structure of any clause or example herein, in particular, any one of Clauses 31-37, wherein the first value, the second value, or both are 100 MPa.
Clause 39. The engineered structure of any clause or example herein, in particular, any one of Clauses 31-37, wherein the mechanical strength of each first layer, the mechanical strength of each third layer, or both are in a range of 100-600 MPa, inclusive.
Clause 40. The engineered structure of any clause or example herein, in particular, any one of Clauses 1-39, wherein the first value is about 100 MPa, or the first value is in a range of 100-600 MPa, inclusive.
Clause 41. The engineered structure of any clause or example herein, in particular, any one of Clauses 1-40, wherein the first laminate has a first cross-sectional area, and the first laminate has a mechanical strength greater than a laminate structure having the first cross-sectional area and formed using only the one or more second layers with the one or more glues. Clause 42. The engineered structure of any clause or example herein, in particular, any one of Clauses 1-40, wherein the first laminate has a first cross-sectional area and a mechanical strength, and the first cross-sectional area is less than that of a laminate structure having the same mechanical strength and formed using only the one or more second layers with the one or more glues.
Clause 43. An engineered structural material comprising:
one or more laminate structures, each laminate structure having a plurality of constituent plant material layers, each plant material layer being coupled to an adjacent plant material layer via one or more respective glues, at least one of the plurality of constituent plant material layers being a densified plant material layer having a density greater than or equal to 1.15 g/cm³.
Clause 44. The engineered structural material of any clause or example herein, in particular, Clause 43, wherein the densified plant material layer is a densified wood or densified bamboo.
Clause 45. The engineered structural material of any clause or example herein, in particular, any one of Clauses 43-44, wherein the densified plant material layer has a density greater than or equal to 1.2 g/cm³.
Clause 46. The engineered structural material of any clause or example herein, in particular, any one of Clauses 43-45, wherein the densified plant material layer has a density greater than or equal to 1.3 g/cm³.
Clause 47. The engineered structural material of any clause or example herein, in particular, any one of Clauses 43-46, wherein the densified plant material layer comprises one or more pieces of densified wood or densified bamboo, with cellulose-based lumina of a native microstructure of the wood or bamboo being substantially collapsed.
Clause 48. The engineered structural material of any clause or example herein, in particular, any one of Clauses 43,-47 wherein the densified plant material layer comprises at least partially delignified plant material or lignin-modified plant material.
Clause 49. The engineered structural material of any clause or example herein, in particular, any one of Clauses 43-48, wherein the one or more glues comprises epoxy, polyurethane adhesive, polyvinyl acetate-isocyanate adhesive, resorcinol formaldehyde resin adhesive, phenolic resin, sodium carboxymethyl cellulose (CMC), or any combination of the foregoing.
Clause 50. The engineered structural material of any clause or example herein, in particular, any one of Clauses 43-49, wherein the one or more laminate structures is formed as a cross-laminated timber (CLT) structure, a glued laminated timber (glulam) structure, a laminated veneer lumber (LVL) structure, an oriented strand board (OSB) structure, or part of an I-joist structure.
Clause 51. The engineered structural material of any clause or example herein, in particular, any one of Clauses 43-50, wherein each of the plurality of constituent plant material layers is either a non-densified plant material layer having a density less than 1.15 g/cm³ or a densified plant material layer having a density of at least 1.15 g/cm³.
Clause 52. The engineered structural material of any clause or example herein, in particular, any one of Clauses 43-50, wherein each of the plurality of constituent plant material layers is either a native plant material layer having a density less than 1.15 g/cm³ or a densified plant material layer having a density of at least 1.15 g/cm³.
Clause 53. A method comprising:
providing one or more first layers, each first layer comprising a densified plant material having a density greater than or equal to 1.15 g/cm³ and a mechanical strength greater than or equal to a first value;
providing one or more second layers, each second layer comprising a plant material having a density less than 1.15 g/cm³ and a mechanical strength less than the first value; and
coupling the one or more first layers to the one or more second layers via one or more respective glues so as to form a laminate.
Clause 54. The method of any clause or example herein, in particular, Clause 53, wherein:
(b1) the plant material of one, some, or all of the one or more first layers comprises densified wood or densified bamboo;
(b2) the plant material of one, some, or all of the one or more seconds layers comprises non-densified wood or non-densified bamboo; or
both (b1) and (b2).
Clause 55. The method of any clause or example herein, in particular, any one of Clauses 53-54, wherein:
(b3) the plant material of one, some, or all of the one or more first layers comprises densified wood or densified bamboo;
(b4) the plant material of one, some, or all of the one or more second layers comprises native wood or native bamboo; or
both (b3) and (b4).
Clause 56. The method of any clause or example herein, in particular, any one of Clauses 53-55, wherein:
the density of one, some, or all of the one or more first layers is greater than or equal to 1.2 g/cm³;
the density of one, some, or all of the one or more first layers is greater than or equal to 1.3 g/cm³;
the density of one, some, or all of the one or more second layers is less than or equal to 1.0 g/cm³;
the density of one, some, or all of the one or more second layers is less than or equal to 0.9 g/cm³; or
any combination of the foregoing.
Clause 57. The method of any clause or example herein, in particular, any one of Clauses 53-56, wherein the providing the one or more first layers comprises:
subjecting one or more pieces of natural plant material having native lignin therein to a chemical treatment so as to compromise the native lignin, thereby forming one or more pieces of lignin-compromised plant material; and
compressing the one or more pieces of lignin-compromised plant material to form the densified plant material of the one or more first layers,
wherein the density of the densified plant material after the compressing is greater than a density of the natural plant material prior to the subjecting.
Clause 58. The method of any clause or example herein, in particular, Clause 57, wherein the compressing is in a direction crossing a longitudinal growth direction of the one or more pieces of lignin-compromised plant material.
Clause 59. The method of any clause or example herein, in particular, any one of Clauses 57-58, wherein the compressing comprises pressing the one or more pieces of lignin-compromised plant material at a pressure of at least 1 MPa.
Clause 60. The method of any clause or example herein, in particular, any one of Clauses 57-59, wherein the compressing comprises pressing the one or more pieces of lignin-compromised plant material at a pressure in a range of 5-20 MPa, inclusive.
Clause 61. The method of any clause or example herein, in particular, any one of Clauses 57-60, wherein the compressing comprises pressing the one or more pieces of lignin-compromised plant material while subjecting to a temperature of at least 50 °C
Clause 62. The method of any clause or example herein, in particular, any one of Clauses 57-61, wherein the compressing comprises pressing the one or more pieces of lignin-compromised plant material while subjecting to a temperature in a range of 80 -180 °C, inclusive.
Clause 63. The method of any clause or example herein, in particular, Clause 57-62, wherein, after the subjecting, the one or more pieces of lignin-compromised plant material has modified lignin therein, and the modified lignin has shorter macromolecular chains than that of native lignin in the piece of natural plant material.
Clause 64. The method of any clause or example herein, in particular, Clause 63, wherein the subjecting to the chemical treatment comprises:
infiltrating the one or more pieces of natural plant material with one or more chemical solutions; and
after the infiltrating, subjecting the one or more pieces of natural plant material with the one or more chemical solutions therein to a first temperature of at least 80 °C for a first time, so as to form the one or more pieces of lignin-compromised plant material.
Clause 65. The method of any clause or example herein, in particular, Clause 64, wherein the one or more chemical solutions comprise p-toluenesulfonic acid, NaOH, NaOH+Na₂SO₃/Na₂SO₄, NaOH+Na₂S, NaHSO₃+SO₂+H₂O, NaHSO₃+Na₂SO₃, NaOH+Na₂SO₃, NaOH/NaH₂O₃+AQ, NaOH/Na₂S+AQ, NaOH+Na₂SO₃+AQ, Na₂SO₃+NaOH+CH₃OH+AQ, NaHSO₃+SO₂+AQ, NaOH+Na₂Sx, where AQ is Anthraquinone, any of the foregoing with NaOH replaced by LiOH or KOH, or any combination of the foregoing.
Clause 66. The method of any clause or example herein, in particular, any one of Clauses 64-65, wherein:
the first temperature is in a range of 120-160 °C, inclusive; and/or
the first time is in a range of 1-5 hours, inclusive.
Clause 67. The method of any clause or example herein, in particular, any one of Clauses 64-66, wherein at least 90% of the one or more chemical solutions infiltrated into the one or more pieces of natural plant material is consumed by the subjecting to the first temperature for the first time.
Clause 68. The method of any clause or example herein, in particular, any one of Clauses 64-67, wherein the subjecting to the first temperature for the first time comprises using steam to heat the one or more pieces of natural plant material with the one or more chemical solutions therein.
Clause 69. The method of any clause or example herein, in particular, any one of Clauses 64-68, wherein, after the subjecting to the first temperature for the first time:
(b5) a content of modified lignin in the one or more pieces of lignin-compromised plant material is at least 90%, on a weight percentage basis, of a content of the native lignin in the one or more pieces of natural plant material;
(b6) a content of modified lignin in the one or more pieces of lignin-compromised plant material is at least 20 wt %; or
both (b5) and (b6).
Clause 70. The method of any clause or example herein, in particular, any one of Clauses 64-69, wherein, after the subjecting to the first temperature for the first time, a salt of an alkaline chemical is immobilized within a cellulose-based microstructure of the one or more pieces of lignin-compromised plant material.
Clause 71. The method of any clause or example herein, in particular, Clause 70, wherein the salt is substantially pH-neutral.
Clause 72. The method of any clause or example herein, in particular, any one of Clauses 70-71, wherein the salt is formed by reaction of the one or more chemical solutions with an acidic degradation product of native hemicellulose in the one or more pieces of natural plant material produced by the one or more chemical solutions.
Clause 73. The method of any clause or example herein, in particular, any one of Clauses 57-62, wherein, after the subjecting to a chemical treatment, the one or more pieces of lignin-compromised plant material is at least partially delignified.
Clause 74. The method of any clause or example herein, in particular, Clause 73, wherein the subjecting to the chemical treatment comprises partial or full immersion of the one or more pieces of natural plant material in one or more chemical solutions at a second temperature for a second time, so as to remove at least some lignin from the one or more pieces of natural plant material.
Clause 75. The method of any clause or example herein, in particular, Clause 74, wherein the one or more chemical solutions comprise an alkaline solution.
Clause 76. The method of any clause or example herein, in particular, any one of Clauses 74-75, wherein the one or more chemical solutions comprise sodium hydroxide (NaOH), lithium hydroxide (LiOH), potassium hydroxide (KOH), sodium sulfite (Na₂SO₃), sodium sulfate (Na₂SO₄), sodium sulfide (Na₂S), NaₙS wherein n is an integer, urea (CH₄N₂O), sodium bisulfite (NaHSO₃), NaH₂O₃, sulfur dioxide (SO₂), anthraquinone (C₁₄H₈O₂), methanol (CH₃OH), ethanol (C₂H₅OH), butanol (C₄H₉OH), formic acid (CH₂O₂), hydrogen peroxide (H₂O₂), acetic acid (CH₃COOH), butyric acid (C₄H₈O₂), peroxyformic acid (CH₂O₃), peroxyacetic acid (C₂H₄O₃), ammonia (NH₃), tosylic acid (p-TsOH), sodium hypochlorite (NaClO), sodium chlorite (NaClO₂), chlorine dioxide (ClO₂), chorine (Cl₂), water (H₂O) or any combination of the foregoing.
Clause 77. The method of any clause or example herein, in particular, any one of Clauses 74-76, wherein the one or more chemical solutions comprise a boiling mixture of NaOH and Na₂SO₃.
Clause 78. The method of any clause or example herein, in particular, any one of Clauses 74-77, wherein:
(b 7) the second temperature is in a range of 100-160 °C, inclusive;
(b8) the second time is in a range of 0.1-96 hours, inclusive; or
both (b7) and (b8).
Clause 79. The method of any clause or example herein, in particular, any one of Clauses 74-78, wherein a lignin content of the one or more pieces of lignin-compromised plant material is between 5% and 95%, inclusive, of a lignin content of the natural plant material.
Clause 80. The method of any clause or example herein, in particular, any one of Clauses 74-79, wherein:
the native plant material is a hardwood or bamboo, and a lignin content of the lignin-compromised plant material is between 0.9 wt % and 23.8 wt %, inclusive; or
the native plant material is a softwood, and a lignin content of the lignin-compromised plant material is between 1.25 wt % and 33.25 wt %, inclusive.
Clause 81. The method of any clause or example herein, in particular, any one of Clauses 74-80, wherein a lignin content of the lignin-compromised plant material is at least 10 wt %.
Clause 82. The method of any clause or example herein, in particular, any one of Clauses 53-81, wherein:
(b9) each first layer consists essentially of densified plant material;
(b10) each second layer consists essentially of non-densified or native plant material; or
both (b9) and (b10).
Clause 83. The method of any clause or example herein, in particular, any one of Clauses 53-82, wherein the one or more respective glues comprise epoxy, polyurethane adhesive, polyvinyl acetate-isocyanate adhesive, resorcinol formaldehyde resin adhesive, phenolic resin, sodium carboxymethyl cellulose (CMC), or any combination of the foregoing.
Clause 84. The method of any clause or example herein, in particular, any one of Clauses 53-83, wherein the first and second layers are coupled in the form of a reinforced cross-laminated timber structure, a reinforced glued laminated structure, a reinforced laminated veneer structure, an oriented strand board structure, an I-joist structure, or a part of any of the foregoing.
Clause 85. The method of any clause or example herein, in particular, any one of Clauses 53-84, wherein one, some, or all of the one or more second layers comprises a non-densified plant material.

### Conclusion

Any of the features illustrated or described herein, for example, with respect to FIGS. 1A-6 and Clauses 1-85, can be combined with any other feature illustrated or described herein, for example, with respect to FIGS. 1A-6 and Clauses 1-85 to provide materials, systems, devices, structures, methods, and embodiments not otherwise illustrated or specifically described herein. All features described herein are independent of one another and, except where structurally impossible, can be used in combination with any other feature described herein. In view of the many possible embodiments to which the principles of the disclosed technology may be applied, it should be recognized that the illustrated embodiments are only examples and should not be taken as limiting the scope of the disclosed technology. Rather, the scope is defined by the following claims. We therefore claim all that comes within the scope and spirit of these claims.

1. An engineered structure comprising:
a first laminate comprising a plurality of constituent plant material layers, the plurality of constituent plant material layers comprising one or more first layers and one or more second layers, each plant material layer being adhered to an adjacent plant material layer via one or more respective glues,
wherein each first plant material layer is a densified plant material layer having a density greater than or equal to 1.15 g/cm³ and a mechanical strength greater than or equal to a first value, and
each second plant material layer is a plant material layer having a density less than 1.15 g/cm³ and a mechanical strength less than the first value.

2. The engineered structure of claim 1, wherein the plant material forming one, some, or all of the constituent layers in the first laminate is a wood or bamboo.

3-8. (canceled)

9. The engineered structure of claim 1, wherein one, some, or all of the one or more second layers comprises one or more pieces of non-densified plant material that retains a native microstructure of cellulose-based lumina of the plant material.

10. The engineered structure of claim 1, wherein one, some, or all of the one or more first layers comprises one or more pieces of densified plant material, with cellulose-based lumina of a native microstructure of the plant material being substantially collapsed.

11. (canceled)

12. The engineered structure of claim 1, wherein:
one, some, or all of the one or more first layers comprises lignin-compromised plant material,
the lignin-compromised plant material comprises modified lignin therein, and
the modified lignin has shorter macromolecular chains than that of native lignin in the natural plant material.

13-16. (canceled)

17. The engineered structure of claim 1, wherein:
one, some, or all of the one or more first layers comprises lignin-compromised plant material, and
the lignin-compromised plant material comprises at least partially delignified wood.

18-25. (canceled)

26. The engineered structure of claim 1, wherein:
one, some, or all of the one or more first layers is disposed as a respective outermost layer of the first laminate; or
the one or more first layers encloses the one or more second layers in a cross-sectional view.

27. The engineered structure of claim 1, wherein the one or more first layers fully encloses the one or more second layers on all sides.

28. The engineered structure of claim 1, wherein:
the second layers comprise a stack of plant material boards arranged such that adjacent plant material boards have orthogonal orientations, and
the stack of plant material boards is disposed between a pair of the first layers so as to form a reinforced cross-laminated timber (CLT) structure.

29-30. (canceled)

31. The engineered structure of claim 1, further comprising:
a second laminate comprising a second plurality of constituent plant material layers, the second plurality of constituent plant material layers comprising one or more third layers and one or more fourth layers, each plant material layer being adhered to an adjacent plant material layer via one or more respective glues; and
a web extending between the first and second laminates,
wherein each third layer is a densified plant material layer having a density greater than or equal to 1.15 g/cm³ and a mechanical strength greater than or equal to a second value,
each fourth layer is a plant material layer having a density less than 1.15 g/cm³ and a mechanical strength less than the second value,
the web and the first and second laminates together form an I-joist, and
the first and second laminates form first and second flanges, respectively, of the I-joist.

32-42. (canceled)

43. An engineered structural material comprising:
one or more laminate structures, each laminate structure having a plurality of constituent plant material layers, each plant material layer being coupled to an adjacent plant material layer via one or more respective glues, at least one of the plurality of constituent plant material layers being a densified plant material layer having a density greater than or equal to 1.15 g/cm³.

44-46. (canceled)

47. The engineered structural material of claim 43, wherein the densified plant material layer comprises one or more pieces of densified wood or densified bamboo, with cellulose-based lumina of a native microstructure of the wood or bamboo being substantially collapsed.

48. The engineered structural material of claim 43, wherein the densified plant material layer comprises at least partially delignified plant material or lignin-modified plant material.

49-52. (canceled)

53. A method comprising:
providing one or more first layers, each first layer comprising a densified plant material having a density greater than or equal to 1.15 g/cm³ and a mechanical strength greater than or equal to a first value;
providing one or more second layers, each second layer comprising a plant material having a density less than 1.15 g/cm³ and a mechanical strength less than the first value; and
coupling the one or more first layers to the one or more second layers via one or more respective glues so as to form a laminate.

54-56. (canceled)

57. The method of claim 53, wherein the providing the one or more first layers comprises:
subjecting one or more pieces of natural plant material having native lignin therein to a chemical treatment so as to compromise the native lignin, thereby forming one or more pieces of lignin-compromised plant material; and
compressing the one or more pieces of lignin-compromised plant material to form the densified plant material of the one or more first layers,
wherein the density of the densified plant material after the compressing is greater than a density of the natural plant material prior to the subjecting.

58-62. (canceled)

63. The method of claim 57, wherein, after the subjecting, the one or more pieces of lignin-compromised plant material has modified lignin therein, and the modified lignin has shorter macromolecular chains than that of native lignin in the piece of natural plant material.

64. The method of claim 63, wherein the subjecting to the chemical treatment comprises:
infiltrating the one or more pieces of natural plant material with one or more chemical solutions; and
after the infiltrating, subjecting the one or more pieces of natural plant material with the one or more chemical solutions therein to a first temperature of at least 80 °C for a first time, so as to form the one or more pieces of lignin-compromised plant material.

65-69. (canceled)

70. The method of claim 64, wherein, after the subjecting to the first temperature for the first time, a salt of an alkaline chemical is immobilized within a cellulose-based microstructure of the one or more pieces of lignin-compromised plant material, and the salt is formed by reaction of the one or more chemical solutions with an acidic degradation product of native hemicellulose in the one or more pieces of natural plant material produced by the one or more chemical solutions.

71-72. (canceled)

73. The method of claim 57, wherein, after the subjecting to a chemical treatment, the one or more pieces of lignin-compromised plant material is at least partially delignified.

74-83. (canceled)

84. The method of claim 53, wherein the first and second layers are coupled in the form of a reinforced cross-laminated timber structure, a reinforced glued laminated structure, a reinforced laminated veneer structure, an oriented strand board structure, an I-joist structure, or a part of any of the foregoing.

85. (canceled)
